(19) United States
(12) Patent Application Publication
(10) Pub. No.: US 2026/0223118 A1
(43) Pub. Date: Jul. 30, 2026

(54) UCI MULTIPLEXING ON MULTI-CODEWORD AND MULTI-BEAM PUSCH

(71) Applicant: Google LLC, Mountain View, CA (US)

(72) Inventor: Yushu ZHANG, Beijing (CN)

(21) Appl. No.: 19/148,668

(22) PCT Filed: Feb. 17, 2023
(86) PCT No.: PCT/CN2023/076868

§ 371 Date: Jul. 16, 2025

(51) Int. Cl. H04W 72/21; H04L 1/00

(52) U.S. Cl. CPC H04W 72/21; H04L 1/0003

(57) ABSTRACT

This disclosure provides systems, devices, apparatus, and methods, including computer programs encoded on storage media, for multiplexing UCI (508) for multiple codewords on one or more beams. A UE (102) multiplexes, on PUSCH resources (202), UCI (508) for a plurality of codewords to generate a multiplexed UCI. The plurality of codewords is associated with the one or more beams. The UE (102) transmits (316, 716), to a network entity (104), the multiplexed UCI (508) on the PUSCH resources (202).

### TECHNICAL FIELD

The present disclosure relates generally to wireless communication, and more particularly, to multiplexing uplink control information (UCI) for multiple codewords on one or more beams.

### BACKGROUND

The Third Generation Partnership Project (3GPP) specifies a radio interface referred to as fifth generation (5G) new radio (NR) (5G NR). An architecture for a 5G NR wireless communication system includes a 5G core (5GC) network, a 5G radio access network (5G-RAN), a user equipment (UE), etc. The 5G NR architecture seeks to provide increased data rates, decreased latency, and/or increased capacity compared to prior generation cellular communication systems.

Wireless communication systems, in general, may be configured to provide various telecommunication services (e.g., telephony, video, data, messaging, broadcasts, etc.) based on multiple-access technologies, such as orthogonal frequency division multiple access (OFDMA) technologies, that support communication with multiple UEs. Improvements in mobile broadband continue the progression of such wireless communication technologies. For example, a UE can multiplex uplink control information (UCI) on allocated physical uplink shared channel (PUSCH) resources that overlap in time with physical uplink control channel (PUCCH) resources configured for UCI transmission. However, the UE may be scheduled to transmit using multiple codewords (e.g., with different modulation orders or different coding rates) or on multiple beams, which may result in increased complexities at the UE.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

A network entity, such as a base station or a unit of a base station, may configure a user equipment (UE) to transmit uplink control information (UCI) on physical uplink control channel (PUCCH) resources. In situations where the PUCCH resources overlap in time with physical uplink shared channel (PUSCH) resources allocated to the UE, the UE may transmit the UCI to the network entity on the allocated PUSCH resources. The UCI may include information such as a scheduling request, hybrid automatic repeat request-acknowledgment (HARQ-ACK), channel state information (CSI) part 1, and/or CSI part 2.

While the UE may transmit the UCI to the network entity on the PUSCH resources when the allocated PUSCH resources overlap in the time domain with the PUCCH resources, the network entity may also schedule that UE to transmit using multiple codewords (e.g., with different modulation and coding schemes (MCSs)) or on multiple beams. Hence, in a multi-codeword scenario, the UE uses codewords instructing a different modulation order or a different target coding rate. In a multi-beam scenario, the PUSCH resources could correspond to different UE panels that are transmitting to different transmission-reception points (TRPs). Thus, for multi-codeword and/or multi-beam scenarios, transmitting the UCI on the allocated PUSCH resources results in increased complexities.

Aspects of the present disclosure address the above-noted and other deficiencies by multiplexing the UCI for the multiple codewords or the multiple beams on the allocated PUSCH resources, where the allocated PUSCH resources overlap in time with the PUCCH resources. In some examples, the network entity may indicate a multiplexing scheme to the UE for multiplexing the UCI on the PUSCH resources. In other examples, the UE independently determines the multiplexing scheme for the UCI associated with the multiple codewords or the multiple beams.

According to some aspects, the UE multiplexes, on the UE's allocated PUSCH resources, UCI for a plurality of codewords to generate a multiplexed UCI, the plurality of codewords being associated with one or more. The UE transmits, to the network entity, the UCI on the PUSCH resources based on a multiplexing scheme for the UCI.

According to some aspects, the network entity transmits, to the UE, a configuration for UCI on PUCCH resources. The network entity receives, from the UE, the UCI multiplexed on PUSCH resources. The UCI is for a plurality of codewords associated with one or more beams.

### BRIEF DESCRIPTION OF THE DRAWINGS

FIG. 1 illustrates a diagram of a wireless communications system that includes a plurality of user equipments (UEs) and network entities in communication over one or more cells.

FIGS. 2A-2D illustrate diagrams of uplink resources for transmitting uplink control information (UCI).

FIG. 3 illustrates a signaling diagram for a multi-codeword physical uplink shared channel (PUSCH) transmission based on UCI multiplexing.

FIGS. 4A-4C illustrate resource diagrams of codewords with and without UCI.

FIGS. 5A-5C illustrate resource diagrams of codewords associated with UCI repetitions (or UCI partitions).

FIGS. 6A-6C illustrate resource diagrams of codewords associated with a hybrid multiplexing of types of UCI.

FIG. 7 illustrates a signaling diagram for a multi-beam PUSCH transmission based on UCI multiplexing.

FIGS. 8A-8C illustrate resource diagrams associated with UCI multiplexing.

FIGS. 9A-9C illustrate resource diagrams associated with UCI multiplexing.

FIG. 10 is a flowchart of a method of wireless communication at a UE.

FIG. 11 is a flowchart of a method of wireless communication at a network entity.

FIG. 12 is a diagram illustrating a hardware implementation for an example UE apparatus.

FIG. 13 is a diagram illustrating a hardware implementation for one or more example network entities.

### DETAILED DESCRIPTION

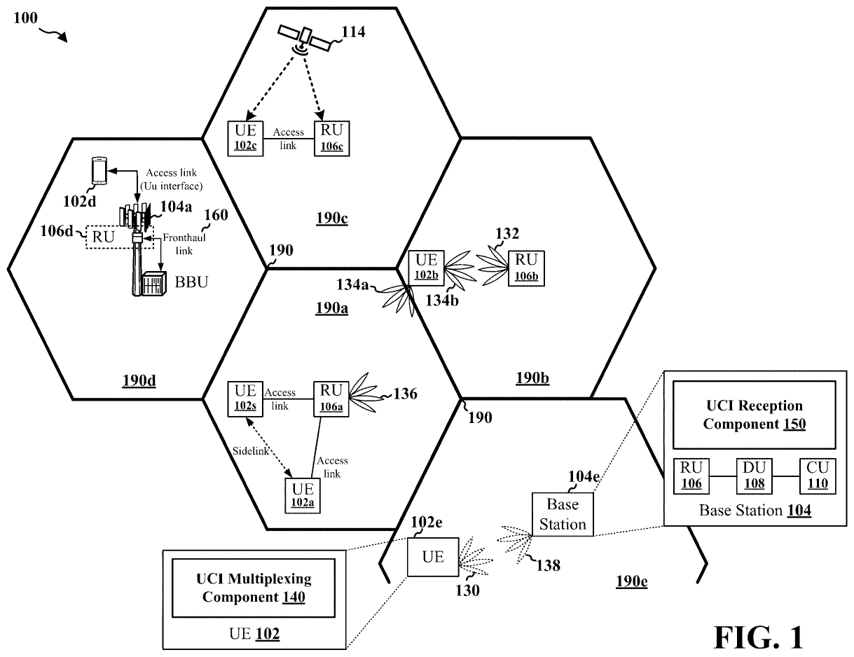

FIG. 1 illustrates a diagram 100 of a wireless communications system associated with a plurality of cells 190. The wireless communications system includes user equipments (UEs) 102 and base stations/network entities 104. Some base stations may include an aggregated base station architecture and other base stations may include a disaggregated base station architecture. The aggregated base station architecture includes a radio unit (RU) 106, a distributed unit (DU) 108, and a centralized unit (CU) 110 that are configured to utilize a radio protocol stack that is physically or logically integrated within a single radio access network (RAN) node. A disaggregated base station architecture utilizes a protocol stack that is physically or logically distributed among two or more units (e.g., RUs 106, DUs 108, CUs 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Each of the RU 106, the DU 108 and the CU 110 can be implemented as virtual units, such as a virtual radio unit (VRU), a virtual distributed unit (VDU), or a virtual central unit (VCU). The base station/network entity 104 (e.g., an aggregated base station or disaggregated units of the base station, such as the RU 106, the DU 108, or the CU 110), may be referred to as a transmission reception point (TRP).

Operations of the base station 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN), which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the base stations 104a/104e and/or the RUs 106a-106d may communicate with the UEs 102a-102d and 102s via one or more radio frequency (RF) access links based on a Uu interface. In examples, multiple RUs 106 and/or base stations 104 may simultaneously serve the UEs 102, such as by intra-cell and/or inter-cell access links between the UEs 102 and the RUs 106/base stations 104.

The RU 106, the DU 108, and the CU 110 may include (or may be coupled to) one or more interfaces configured to transmit or receive information/signals via a wired or wireless transmission medium. A base station 104 or any of the one or more disaggregated base station units can be configured to communicate with one or more other base stations 104 or one or more other disaggregated base station units via the wired or wireless transmission medium. In examples, a processor, a memory, and/or a controller associated with executable instructions for the interfaces can be configured to provide communication between the base stations 104 and/or the one or more disaggregated base station units via the wired or wireless transmission medium. For example, a wired interface can be configured to transmit or receive the information/signals over a wired transmission medium, such as via the fronthaul link 160 between the RU 106d and the baseband unit (BBU) 112 of the base station 104d associated with the cell 190d. The BBU 112 includes a DU 108 and a CU 110, which may also have a wired interface (e.g., midhaul link) configured between the DU 108 and the CU 110 to transmit or receive the information/signals between the DU 108d and the CU 110d. In further examples, a wireless interface, which may include a receiver, a transmitter, or a transceiver, such as an RF transceiver, configured to transmit and/or receive the information/signals via the wireless transmission medium, such as for information communicated between the RU 106a of the cell 190a and the base station 104e of the cell 190e via cross-cell communication beams 136-138 of the RU 106a and the base station 104e.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RU 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134b of the UE 102b, which may correspond to inter-cell communication beams or, in some examples, cross-cell communication beams. For instance, the UE 102b of the cell 190b may communicate with the RU 106a of the cell 190a via a third set of communication beams 134a of the UE 102b and a fourth set of communication beams 136 of the RU 106a. Both real-time and non-real-time features of control plane and user plane communications of the RUs 106 can be controlled by associated DUs 108.

Any combination of the RU 106, the DU 108, and the CU 110, or reference thereto individually, may correspond to a base station 104. Thus, the base station 104 may include at least one of the RU 106, the DU 108, or the CU 110. The base stations 104 provide the UEs 102 with access to a core network. The base stations 104 might relay communications between the UEs 102 and the core network. The base stations 104 may be associated with macrocells for high-power cellular base stations and/or small cells for low-power cellular base stations. For example, the cell 190e may correspond to a macrocell, whereas the cells 190a-190d may correspond to small cells. Small cells include femtocells, picocells, microcells, etc. A cell structure that includes at least one macrocell and at least one small cell may be referred to as a “heterogeneous network.”

Transmissions from a UE 102 to a base station 104/RU 106 are referred to as uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas 114 of the base station 104d of cell 190d to transmit a downlink/forward link communication to the UE 102d or receive an uplink/reverse link communication from the UE 102d based on the Uu interface associated with the access link between the UE 102d and the base station 104d/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, 800, 1600, 2000, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, more or fewer carriers may be allocated to either the uplink or the downlink. A primary component carrier and one or more secondary component carriers may be included in the component carriers. The primary component carrier may be associated with a primary cell (PCell) and a secondary component carrier may be associated with as a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. The sidelink communication/D2D link may also use one or more sidelink channels, such as a physical sidelink broadcast channel (PSBCH), a physical sidelink discovery channel (PSDCH), a physical sidelink shared channel (PSSCH), and/or a physical sidelink control channel (PSCCH), to communicate information between UEs 102a and 102s. Such sidelink/D2D communication may be performed through various wireless communications systems, such as wireless fidelity (Wi-Fi) systems, Bluetooth systems, Long Term Evolution (LTE) systems, New Radio (NR) systems, etc.

The electromagnetic spectrum is often subdivided into different classes, bands, channels, etc., based on different frequencies/wavelengths associated with the electromagnetic spectrum. Fifth-generation (5G) NR is generally associated with two operating frequency ranges (FRs) referred to as frequency range 1 (FR1) and frequency range 2 (FR2). FR1 ranges from 410 MHz-7.125 GHz and FR2 ranges from 24.25 GHz-71.0 GHz, which includes FR2-1 (24.25 GHz-52.6 GHz) and FR2-2 (52.6 GHz-71.0 GHz). Although a portion of FR1 is actually greater than 6 GHz, FR1 is often referred to as the “sub-6 GHz” band. In contrast, FR2 is often referred to as the “millimeter wave” (mmW) band. FR2 is different from, but a near subset of, the “extremely high frequency” (EHF) band, which ranges from 30 GHz-300 GHz and is sometimes also referred to as a “millimeter wave” band. Frequencies between FR1 and FR2 are often referred to as “mid-band” frequencies. The operating band for the mid-band frequencies may be referred to as frequency range 3 (FR3), which ranges 7.125 GHZ-24.25 GHz. Frequency bands within FR3 may include characteristics of FR1 and/or FR2. Hence, features of FR1 and/or FR2 may be extended into the mid-band frequencies. Higher operating frequency bands have been identified to extend 5G NR communications above 52.6 GHz associated with the upper limit of FR2. Three of these higher operating frequency bands include FR2-2, which ranges from 52.6 GHZ-71.0 GHz, FR4, which ranges from 71.0 GHz-114.25 GHz, and FR5, which ranges from 114.25 GHZ-300 GHz. The upper limit of FR5 corresponds to the upper limit of the EHF band. Thus, unless otherwise specifically stated herein, the term “sub-6 GHz” may refer to frequencies that are less than 6 GHZ, within FR1, or may include the mid-band frequencies. Further, unless otherwise specifically stated herein, the term “millimeter wave”, or mmW, refers to frequencies that may include the mid-band frequencies, may be within FR2-1, FR4, FR2-2, and/or FR5, or may be within the EHF band.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of communication beams 132 to the UE 102b in one or more transmit directions of the RU 106b. The UE 102b may receive the downlink beamformed signal based on a second set of communication beams 134b from the RU 106b in one or more receive directions of the UE 102b. In a further example, the UE 102b may also transmit an uplink beamformed signal to the RU 106b based on the second set of communication beams 134b in one or more transmit directions of the UE 102b. The RU 106b may receive the uplink beamformed signal from the UE 102b in one or more receive directions of the RU 106b.

The UE 102b may perform beam training to determine the best receive and transmit directions for the beamformed signals. The transmit and receive directions for the UEs 102 and the base stations 104/RUs 106 might or might not be the same. In further examples, beamformed signals may be communicated between a first base station/RU 106a and a second base station 104e. For instance, the base station 104e of the cell 190e may transmit a beamformed signal to the RU 106a based on the communication beams 138 in one or more transmit directions of the base station 104e. The RU 106a may receive the beamformed signal from the base station 104e of the cell 190e based on the RU communication beams 136 in one or more receive directions of the RU 106a. In further examples, the base station 104e transmits a downlink beamformed signal to the UE 102e based on the communication beams 138 in one or more transmit directions of the base station 104e. The UE 102e receives the downlink beamformed signal from the base station 104e based on UE communication beams 130 in one or more receive directions of the UE 102e. The UE 102e may also transmit an uplink beamformed signal to the base station 104e based on the UE communication beams 130 in one or more transmit directions of the UE 102e, such that the base station 104e may receive the uplink beamformed signal from the UE 102e in one or more receive directions of the base station 104e.

The base station 104 may include and/or be referred to as a network entity. That is, “network entity” may refer to the base station 104 or at least one unit of the base station 104, such as the RU 106, the DU 108, and/or the CU 110. The base station 104 may also include and/or be referred to as a next generation evolved Node B (ng-eNB), a generation NB (gNB), an evolved NB (eNB), an access point, a base transceiver station, a radio base station, a radio transceiver, a transceiver function, a basic service set (BSS), an extended service set (ESS), a TRP, a network node, network equipment, or other related terminology. The base station 104 or an entity at the base station 104 can be implemented as an IAB node, a relay node, a sidelink node, an aggregated (monolithic) base station with an RU 106 and a BBU 112 that includes a DU 108 and a CU 110, or as a disaggregated base station including one or more RUs 106, DUs 108, and/or CUs 110. A set of aggregated or disaggregated base stations may be referred to as a next generation-radio access network (NG-RAN). In some examples, the UE 102a operates in dual connectivity (DC) with the base station 104e and the base station/RU 106a. In such cases, the base station 104e can be a master node and the base station/RU 160a can be a secondary node.

Uplink/downlink signaling may also be communicated via a satellite positioning system (SPS) 114. In an example, the SPS 114 of the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

Still referring to FIG. 1, in certain aspects, any of the UEs 102 may include an uplink control information (UCI) multiplexing component 140 configured to multiplex, on physical uplink shared channel (PUSCH) resources, UCI for a plurality of codewords to generate a multiplexed UCI, the plurality of codewords being associated with one or more beams; and transmit, to a network entity, the multiplexed UCI on the PUSCH resources.

In certain aspects, any of the base stations 104 or a network entity of the base stations 104 may include a UCI reception component 150 configured to transmit, to a UE, a configuration for UCI on physical uplink control channel (PUCCH) resources; and receive, from the UE, the UCI multiplexed on PUSCH resources, the UCI being for a plurality of codewords associated with one or more beams.

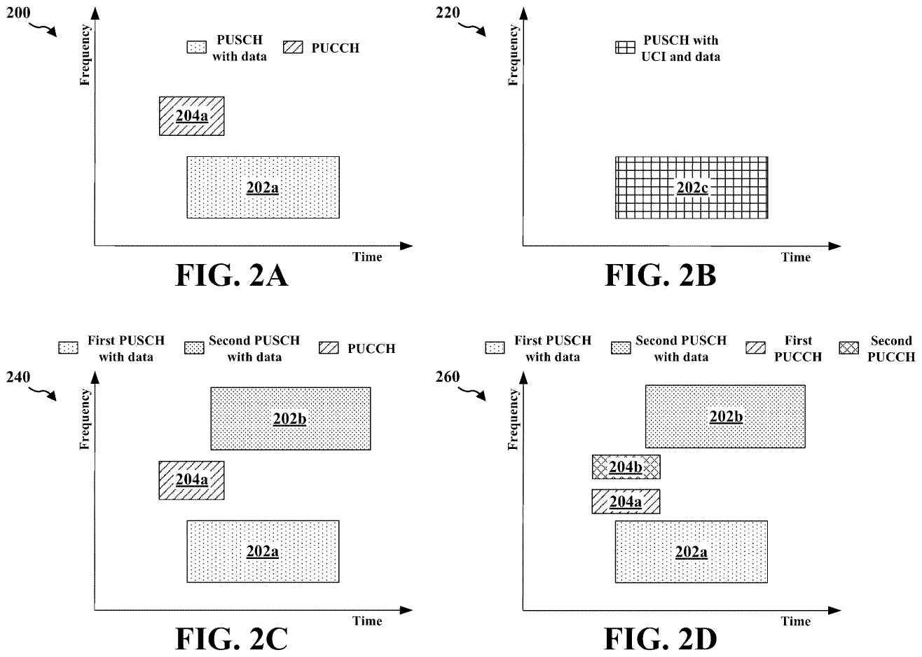

Accordingly, FIG. 1 describes a wireless communication system that may be implemented in connection with aspects of one or more other figures described herein, such as aspects illustrated in FIGS. 2A-9C. Further, although the following description may be focused on 5G NR, the concepts described herein may be applicable to other similar areas, such as 5G-Advanced and future versions, LTE, LTE-advanced (LTE-A), and other wireless technologies, such as 6G.

FIGS. 2A-2D illustrate diagrams 200-260 of uplink resources for transmitting UCI. A network entity can configure a UE to transmit UCI on PUCCH 204a, such as in the diagram 200, or on PUSCH 202c, such as in the diagram 220, based on UCI multiplexing. The UCI may include a scheduling request, hybrid automatic repeat request-acknowledgement (HARQ-ACK), and channel state information (CSI). Thus, the UCI may have 7 permutations that correspond to HARQ-only, scheduling request-only, CSI-only, HARQ and scheduling request, HARQ and CSI, scheduling request and CSI, and HARQ+scheduling request+CSI. However, the UE does not transmit the scheduling request on the PUSCH. The CSI can also include CSI part 1 and CSI part 2, where the CSI part 2 supports variable lengths, such as CSI part 2-only, and may be punctured into two sections by a symbol with demodulation reference signal (DMRS) resource elements and data resource elements. If the network entity configures the UE to transmit the UCI on PUCCH 204 and data on PUSCH 202a and/or 202b in overlapped symbols, such as in the diagrams 200, 240, 260, the UE may transmit the UCI on PUSCH 202c, such as in the diagram 220.

For single-codeword PUSCH transmissions and single-beam PUSCH transmissions, the UE transmits the UCI on first resource elements (REs) of a resource block (RB) and transmits data on the remaining REs of the RB in multiple layers based on a same modulation and coding scheme (MCS). The network entity may configure the number of REs for HARQ-ACK, CSI part 1, and CSI part 2 based on a first beta offset of

$${β}_{offset}^{H ARQ - ACK} ,$$

a second beta offset of

$${β}_{offset}^{CSI - part 1} ,$$

and a third beta offset of

$${β}_{offset}^{CSI - part 2} .$$

The UE determines a coding rate for the HARQ-ACK based on R_{HARQ-ACK}, a coding rate for the CSI part 1 based on R_{CSI-part1}, and a coding rate for the CSI part 2 based on R_{CSI-part2}. The coding rate R for the data and the beta offsets correspond to:

$${R}_{H ARQ - ACK} = R {β}_{offset}^{H ARQ - ACK}$$

$${R}_{CSI - part 1} = R {β}_{offset}^{CSI - part 1}$$

$${R}_{CSI - part 2} = R {β}_{offset}^{CSI - part 2}$$

such that the number of REs for the HARQ-ACK Q_{HARQ-ACK}, the number of REs for CSI part 1 Q_{CSI-part1}, and the number of REs for CSI part 2 Q_{CSI-part2} can be obtained based on the number of bits for HARQ-ACK with cyclic redundancy check (CRC) O_{HARQ-ACK}, the number of bits for CSI part 1 with CRC O_{CSI-part1}, the number of bits for CSI part 2 with CRC O_{CSI-part2}, and the coding rate and modulation order Qₘ as follows:

$${Q}_{H ARQ - ACK} = min ( ⌈ \frac{{O}_{H ARQ - ACK}}{{Q}_{m} {R}_{H ARQ - ACK}} ⌉ , α {N}_{RE} )$$

$${Q}_{CSI - part 1} = ( ⌈ \frac{{O}_{CSI - part 1}}{{Q}_{m} {R}_{CSI - part 1}} ⌉ , α {N}_{R E} ) - {Q}_{H ARQ - ACK}$$

$${Q}_{CSI - part 2} = ( ⌈ \frac{{O}_{CSI - part 2}}{{Q}_{m} {R}_{CSI - part 2}} ⌉ , α {N}_{R E} ) - {Q}_{H ARQ - ACK} - {Q}_{CSI - part 2}$$

where, α corresponds to a scaling factor configured by radio resource control (RRC) signaling from the network entity, N_{RE} corresponds to the number of REs for the PUSCH transmission excluding DMRS.

The network entity may schedule the UE to transmit PUSCH 202 on two codewords, where different MCSs may be configured for each codeword. Thus, a modulation order of Qₘ and the target coding rate R for each codeword may be different. For a UE that is capable of transmitting PUSCH 202 from multiple beams simultaneously, the network entity may schedule the UE to transmit a first PUSCH 202a and a second PUSCH 202b from different beams, and a PUCCH 204 in overlapped symbols, as illustrated in the diagrams 240-260. The network entity may indicate the beam for a PUSCH by indicating a transmission configuration indication or spatial relation information. The network entity may schedule the UE to transmit a first PUSCH 202a and a second PUSCH 202b from different transmission configuration indications or spatial relation information. The first PUSCH 202a and the second PUSCH 202b may be from two different UE panels directed toward two different TRPs. That is, the two different PUSCHs 202a-202b may be associated with different TRPs (e.g., based on different CORESETPoolIndex configured by the network entity through RRC signaling).

Referring to FIG. 2D, the network entity may also schedule the UE to transmit a first PUSCH 202a and a second PUSCH 202b from different beams as well as a first PUCCH 204a and a second PUCCH 204b in overlapped symbols, as illustrated in the diagram 260. The first PUSCH 202a and the first PUCCH 204a may be from a different UE panel than the second PUSCH 202b and the second PUCCH 204b, where the different UE panels may be directed toward different TRPs. That is, the two different PUSCHs 202a-202b and the two different PUCCHs 204a-204b may be associated with different TRPs (e.g., based on the different CORESETPoolIndex configured by the network entity through the RRC signaling). The PUCCHs 204a-204b may carry a same UCI payload or different UCI payloads corresponding to overlapped or non-overlapped time-frequency resources.

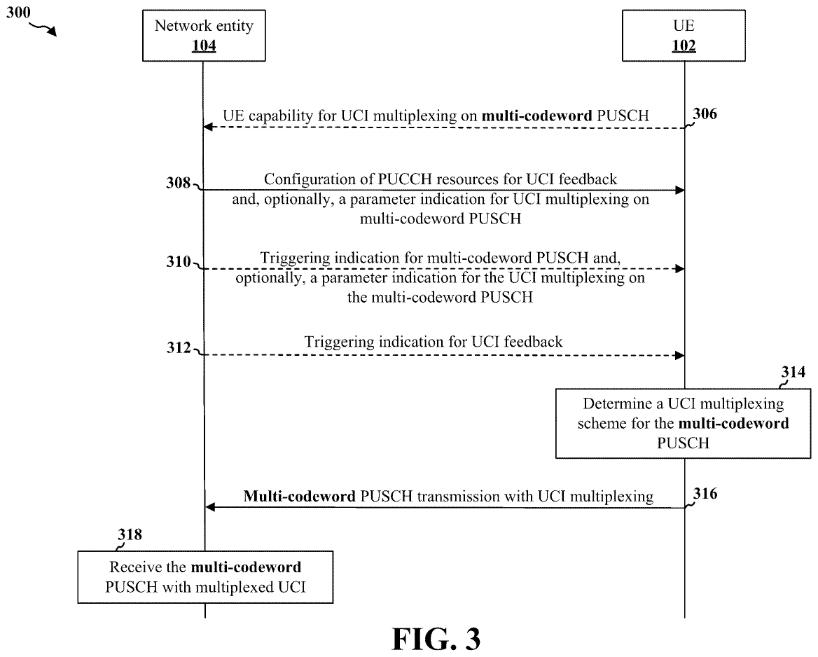

Accordingly, UCI multiplexing for multi-codeword PUSCH and multi-beam PUSCH may allow the UE to transmit UCI on multiple codewords and/or multiple beams. For example, the UE transmits the UCI based on a multi-beam PUSCH when a first PUCCH 204a and/or a second PUCCH 204b has a resource collision with the first PUSCH 202a and the second PUSCH 202b from different beams, as illustrated in the diagrams 240-260. A resource collision refers to communications that have overlapping resources (e.g., a time-domain resource collision may refer to different transmissions that have overlapping symbols). UCI multiplexing on multiple codewords and/or multi-beams may reduce a latency and overhead for UCI reporting, as the UE does not have to transmit the UCI in a PUCCH 204 in addition to data on a PUSCH 202. Thus, FIGS. 2A-2D illustrate PUSCH resources associated with signaling procedures for UCI multiplexing further described in FIG. 3.

FIG. 3 illustrates a signaling diagram 300 for a multi-codeword PUSCH transmission based on UCI multiplexing. The UE 102 may report 306, to the network entity 104, a UE capability for UCI multiplexing on a multi-codeword PUSCH. In other implementations, the network entity 104 may receive an indication of the UE capability from a core network, such as from an access and mobility management function (AMF). In yet other implementations, the network entity 104 may receive the indication of the UE capability from another base station/network entity (e.g., a gNB or an eNB). The UE 102 may transmit 306 the UE capability report (e.g., for UCI multiplexing on multi-codeword PUSCH) to indicate at least one of: whether the UE 102 supports transmitting the UCI on a multi-codeword PUSCH, whether the UE 102 supports transmitting the UCI on one-codeword and/or all codewords of a multi-codeword PUSCH, or whether the UE 102 supports transmitting data in the same REs in other codewords as the REs used for the UCI in one codeword for one-codeword-based UCI multiplexing, etc. The UE 102 may report 306 the UE capability per feature set, per band, per band combination, or per UE.

The network entity 104 indicates 308, to the UE 102, a configuration of PUCCH resources for UCI feedback (e.g., based on the UE capability). The network entity 104 may transmit 308 the configuration for the PUCCH resources for the UCI feedback through control signaling. The network entity 104 may use RRC signaling to indicate an RRCReconfiguration message to the UE 102 or a system information block (SIB), where the SIB may be a traditional type of SIB (e.g., SIB1) or a different SIB (e.g., SIB J, where J corresponds to an integer greater than 21) transmitted by the network entity 104.

For multi-codeword PUSCH transmissions, the network entity 104 may also optionally transmit 308 a parameter indication to the UE 102 that indicates a UCI multiplexing scheme for the multi-codeword PUSCH transmission. For example, the UCI multiplexing scheme may include multiplexing the UCI on one codeword of the multi-codeword PUSCH transmission. As another example, the UCI multiplexing scheme may include multiplexing the UCI on all codewords of the multi-codeword PUSCH transmission. The network entity 104 may configure the UE 102 based on the parameter indication for the UCI multiplexing scheme through the same or different control signaling as transmitted 308 for the configuration of PUCCH resources. For example, the network entity 104 transmits 310, to the UE 102, a triggering indication for the multi-codeword PUSCH that can optionally include the parameter indication for the UCI multiplexing on the multi-codeword PUSCH. Thus, the network entity 104 may transmit 310 the parameter indication with the triggering indication, rather than transmitting 308 the parameter indication with the configuration.

The network entity 104 may additionally transmit 312, to the UE 102 through additional control signaling, a second triggering indication for triggering the UCI feedback from the UE 102. The second triggering indication triggers a PUSCH and a PUCCH that have overlapping resources in time-domain. In some examples, the PUSCH and the PUCCH resource are both configured in the first control signaling transmitted 308 to the UE 102. The network entity 104 may trigger 310 the PUSCH for the UE 102 to report the UCI feedback with or without data (e.g., aperiodic CSI or semi-persistent CSI). The network entity 104 may transmit 310-312 the triggering indication(s) based on a medium access control-control element (MAC-CE) or downlink control information (DCI).

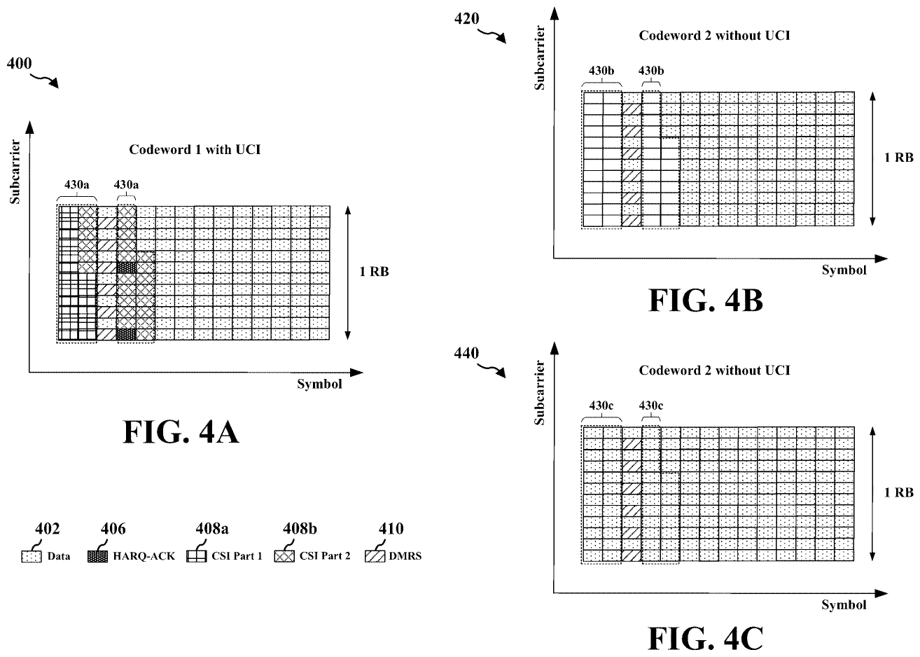

The UE 102 determines whether to multiplex the UCI on PUSCH based on one or more control signals that the UE 102 receives 308, 310, 312 from the network entity 104. Further details on the UE's determination of the UCI multiplexing scheme for the multi-codeword PUSCH will described with respect to FIGS. 4A-6C. The UE 102 may determine 314 the UCI multiplexing scheme for the multi-codeword PUSCH based on the parameter indication. That is, the UE 102 may determine 314 whether to transmit 316 the UCI on one codeword or multiple codewords of the multi-codeword PUSCH transmission or on all codewords of the multi-codeword PUSCH transmission. For example, the UE 102 transmits 316 the UCI on PUSCH based on a multi-codeword PUSCH transmission with the determined UCI multiplexing scheme. The network entity 104 also determines the multiplexing scheme based on the configured/indicated techniques to the UE 102 for receiving 318, from the UE 102, the multi-codeword PUSCH with the multiplexed UCI. FIG. 3 illustrates signaling procedures for a multi-codeword PUSCH, whereas FIGS. 4A-4C illustrate time-frequency resources used for the multi-codeword PUSCH.

FIGS. 4A-4C illustrate resource diagrams 400-440 of codewords with and without UCI. FIG. 4A can be paired with either FIG. 4B or FIG. 4C. In a first example, the UE may transmit the UCI based on a predefined/fixed codeword. The UCI includes the HARQ-ACK 406, the CSI part 1 408a, and the CSI part 2 408b, as illustrated in the diagram 400. The HARQ-ACK 406 may be associated with a smaller payload size (e.g., less than or equal to 11 bits) or a larger payload size (e.g., greater than 11 bits). The codeword may also include data 402 and DMRS 410. The channel coding for the UCI is based on a modulation order and a coding rate for the codeword.

The network entity refrains from scheduling a multi-codeword PUSCH with UCI. For example, the network entity schedules the UCI, as illustrated in the diagram 400, with codeword 1, but refrains from scheduling the UCI, as illustrated in the diagrams 420-440, with codeword 2 (e.g., refrains from scheduling both codewords/multi-codewords with UCI in both codewords 1 and 2). Instead, the REs 430b-430c of codeword 2 that corresponds to the same REs 430a used for the UCI in codeword 1 may be unavailable REs 430b (e.g., empty/unused REs) in codeword 2 for PUSCH rate matching, as illustrated in the diagram 420. Alternatively, the REs 430b-430c of codeword 2 that corresponds to the same REs 430a used for the UCI in codeword 1 may be available REs 430c for data 402 in codeword 2 for the PUSCH rate matching, as illustrated in the diagram 440.

For codewords without UCI (e.g., codeword 2) the network entity may configure whether the REs 430b-430c that correspond to the same REs 430a used for the UCI in codewords with UCI (e.g., codeword 1) are available REs 430c or unavailable REs 430b for PUSCH rate matching through control signaling, such as RRC signaling, MAC-CE, or DCI. The UE may report, to the network entity, a capability of the UE for whether the same REs 430a as used in codewords with UCI, or some types of UCI (e.g., HARQ-ACK 406, CSI part 1 408a, and/or CSI part 2 408b), can be available REs 430c or unavailable REs 430b for PUSCH rate matching. The UE may determine whether the same REs 430a as used in codewords with UCI, or some types of UCI, are available REs 430c or unavailable REs 430b for PUSCH rate matching based on an indicated precoder for a PUSCH transmission. If the precoder indicates a non-coherent transmission or a partial-coherent transmission, the UE determines that the REs in other codewords are available REs 430c. Otherwise, the UE determines that the REs in the other codewords are unavailable REs 430b. The non-coherent transmission or the partial-coherent transmission indicates for at least one layer that at least one PUSCH antenna port includes a zero power (ZP) transmission.

In a second example, the UE may transmit the UCI in a UE-determined codeword, where the channel coding for the UCI is based on a modulation order and a coding rate for the UE-determined codeword. The network entity refrains from scheduling a multi-codeword PUSCH with UCI in multiple codewords. That is, the network entity may schedule the UCI with codeword 1, as illustrated in the diagram 400, but, as illustrated via the diagrams 420-440, refrains from scheduling multiple codewords with UCI (e.g., refrains from scheduling both codewords 1 and 2 with UCI). The UE selects the codeword based on the MCS for each codeword. For example, the UE selects the codeword with a highest MCS to transmit the UCI. If the MCS is the same for both codewords, the UE may select a first codeword or a last codeword of the codewords.

In some implementations, the UE selects the codeword based on a number of coded bits per layer or across layers for the UCI, or some types of UCI (e.g., HARQ-ACK 406, CSI part 1 408a, and/or CSI part 2 408b), in each codeword. If the number of coded bits for multiple codewords are the same, the UE may select the first codeword or the last codeword of the multiple codewords. The UE may determine the number of coded bits for HARQ-ACK 406 corresponding to W_{HARQ-ACK}, the number of coded bits for CSI part 1 408a corresponding to W_{CSI-part1}, and the number of coded bits for CSI part 2 408b corresponding to W_{CSI-part2} across layers in a codeword based on the modulation order for the codeword Qₘ, the number of layers for the codeword L, the number of REs for HARQ-ACK 406 Q_{HARQ-ACK}, the number of REs for CSI part 1 408a Q_{CSI-part1}, and number of REs for CSI part 2 408b Q_{CSI-part2}, as follows:

$${W}_{H ARQ - ACK} = {Q}_{m} L {Q}_{H A R Q - ACK} ,$$

$${W}_{CSI - part 1} = {Q}_{m} L {Q}_{CSI - part 1} ,$$

$${W}_{CSI - part 2} = {Q}_{m} L {Q}_{CSI - part 2} .$$

The UE can select a codeword for UCI multiplexing based on a measured downlink channel quality, scheduling information, and/or a previous transmission status to predict which codeword may have a higher channel quality. For example, if the network entity schedules one of the codewords for initial transmission but another codeword for retransmission, the UE may transmit the UCI on the codeword for the initial transmission, which may indicate that the network entity has successfully received a previous transmission of the codeword. The UE may report, to the network entity via PUSCH, an index for the selected codeword. The network entity may configure N scrambling identifiers (IDs) for DMRS 410 or the data 402 on PUSCH through RRC signaling. The UE transmits the DMRS 410 based on an Nth configured ID, if the UE transmits the UCI on the Nth codeword. The UE may also semi-statically select the codeword for the UCI multiplexing. For instance, the UE may indicate, to the network entity, a preferred codeword through a UE capability report, an RRC message, UE assistance information, or a MAC-CE.

In a third example, the network entity indicates, to the UE, the codeword for the UE to transmit the UCI. The channel coding for the UCI is based on the modulation order and coding rate for the indicated codeword. The network entity can indicate an index for the codeword through RRC signaling (e.g., PUSCH-Config, which provides the configuration for PUSCH transmission in a bandwidth part, UCI-OnPUSCH, which provides configuration for UCI multiplexing for dynamic-grant PUSCH, i.e., PUSCH scheduled by DCI, and/or CG-UCI-OnPUSCH, which provides the configuration for UCI multiplexing for configured-grant PUSCH, i.e., PUSCH with the uplink grant configured by RRC parameters). The network entity can also optionally configure the codeword index for the UE. If the codeword index is not configured, the UE may transmit the UCI on the first codeword. Alternatively, if the codeword index is not configured, which may indicate that a UCI transmission on a multi-codeword PUSCH is disabled, the UE may drop the PUCCH or PUSCH when the PUCCH and PUSCH have overlapping resources in time-domain.

The network entity may also indicate the codeword index through the MAC-CE. The network entity may indicate a serving cell index, a bandwidth part (BWP) index, a codeword index for Type1 configured grant (CG) PUSCH/Type2 CG-PUSCH/dynamic grant PUSCH. The network entity may indicate the codeword index for the Type1 CG-PUSCH, the Type2 CG-PUSCH, or the dynamic grant PUSCH using a single codeword index for a common indication. Alternatively, the network entity may indicate the codeword index for the Type1 CG-PUSCH, the Type2 CG-PUSCH, or the dynamic grant PUSCH based on separate codeword indexes for separate indications. If the codeword index is not configured, the UE may transmit the UCI on the first codeword. Alternatively, if the codeword index is not configured, which may indicate that a UCI transmission on the multi-codeword PUSCH is disabled, the UE may drop the PUCCH or PUSCH when the PUCCH and the PUSCH have overlapping resources in time-domain.

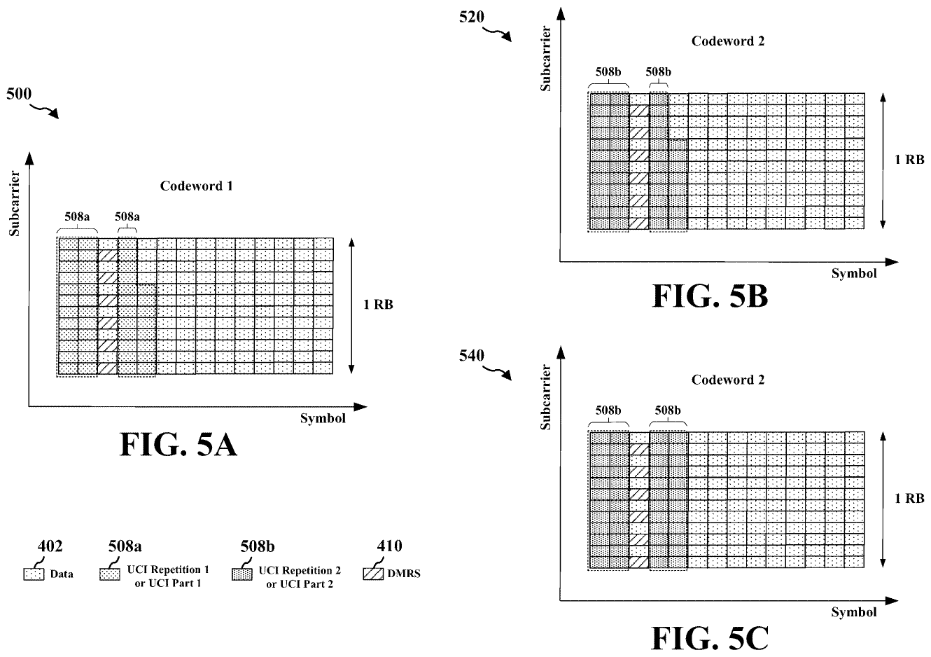

The network entity may further indicate the codeword index through DCI. The DCI may be a same DCI as used to schedule the PUSCH. The network entity may explicitly indicate the codeword index using a DCI field (e.g., codeword index for UCI). Alternatively, the network entity may implicitly indicate the codeword index based on a location of the PDCCH (e.g., a starting control channel element (CCE) index). An odd starting CCE index may indicate the first codeword, whereas an even starting CCE index may indicate the second codeword. FIGS. 4A-4C illustrate UCI for one codeword of a multi-codeword PUSCH transmission, whereas FIGS. 5A-5C illustrate UCI for multiple codewords of a multi-codeword PUSCH transmission.

FIGS. 5A-5C illustrate resource diagrams 500-540 of codewords associated with UCI repetitions (or UCI partitions) 508a-508b. FIG. 5A can be paired with either FIG. 5B or FIG. 5C. The UE may transmit the UCI 508 on multiple codewords (e.g., codeword 1 and codeword 2) based on a first UCI repetition 508a, as illustrated in the diagram 500, and a second UCI repetition 508b, as illustrated in the diagrams 520-540. The channel coding for the UCI 508 is based on the modulation order and coding rate for the multiple codewords. The network entity may configure a common set of beta offsets and a scaling factor for the UCI 508 in the multiple codewords or configure separate sets of beta offsets and scaling factors for the UCI 508 in each codeword.

The diagram 500 illustrates an example for codeword 1, whereas the diagrams 520-540 illustrate different examples for codeword 2. The UE may transmit the UCI repetitions 508 via the multiple codewords. For UCI 508 associated with an N-codeword PUSCH, the UE transmits N UCI repetitions 508. The UE may transmit the second UCI repetition 508b, as illustrated in the diagram 520, in the same REs as used for the first UCI repetition 508a, as illustrated in the diagram 500, or in different REs, as illustrated in the diagram 540. The codewords may also include data 402 and DMRS 410.

The UE may calculate the number of REs per layer or across layers for the UCI 508 based on the number of REs per layer or across layers for a codeword. The UE may also determine an index for the codewords. In other examples, the UE calculates the number of REs per layer or across layers for the UCI 508 based on a maximum, a minimum, or an average number of REs per layer or across layers for a codeword according to the MCS for the codeword. The number of REs for the UCI 508 per layer is indicated as

$${Q}_{UCI}^{j}$$

based on the MCS for codeword j, where the number of REs Q_{UCI} for the UCI 508 per layer can be calculated based on:

$${Q}_{UCI} = max \{ {Q}_{UCI}^{1} , {Q}_{UCI}^{2} , … , {Q}_{UCI}^{J} \}$$

$$or$$

$${Q}_{UCI} = min \{ {Q}_{UCI}^{1} , {Q}_{UCI}^{2} , … , {Q}_{UCI}^{J} \}$$

$$or$$

$${Q}_{UCI} = ⌈ \frac{1}{J} {\sum }_{j = 1}^{J} {Q}_{UCI}^{j} ⌉$$

where J indicates the number of codewords.

The network entity may configure the number of REs for the UCI repetitions 508 (or UCI partitions) in each codeword through RRC signaling, MAC-CE, or DCI. The network entity may also configure whether the number of REs for the UCI 508 is the same for all codewords, or whether the UE determines the number of REs based on the configuration separately for each codeword. The UE may report, to the network entity, a requested or supported number of REs for the UCI repetitions 508 (or UCI partitions) in each codeword via a UE capability or UE assistance information. The UE may also report whether the UE supports the number of REs for the UCI repetitions 508 (or UCI partitions) being the same for all codewords, or whether the UE determines the number of REs based on the configuration separately for each codeword.

In some implementations, the UE transmits part of the UCI 508 (e.g., UCI partitions) in a codeword. For instance, in the diagram 500, the UE may transmit UCI part 1 508a for codeword 1 and, in the diagrams 520-540, the UE may transmit UCI part 2 508b for codeword 2. For UCI 508 on an N-codeword PUSCH, the UE may divide the UCI 508 into N parts and transmit each part in respective codewords. If the UCI 508 includes HARQ-ACK, CSI part 1, and CSI part 2, the UE may similarly divide the HARQ-ACK into N parts, the CSI part 1 into N parts, and the CSI part 2 into N parts to transmit each part in the respective codewords. In other implementations, the UE transmits each part of the UCI 508 in each codeword. If the UCI includes HARQ-ACK, CSI part 1, and CSI part 2, the UE divides the HARQ-ACK into N parts, the CSI part 1 into N parts, and the CSI part 2 into N parts and transmits each of the N parts in each of the N codewords.

The network entity may configure/indicate to the UE whether to transmit the UCI 508 based on UCI repetition techniques or UCI partition techniques through the RRC signaling, the MAC-CE, or the DCI. In examples, the network entity may configure a UCI transmission scheme (e.g., repetition or partition based on spatial-domain multiplexing (SDM)) via PUSCH-Config, UCI-OnPUSCH, or CG-UCI-OnPUSCH. In other examples, the network entity may indicate the UCI transmission scheme using a DCI field. The UE may report supported UCI transmission schemes via the UE capability report and/or UE assistance information.

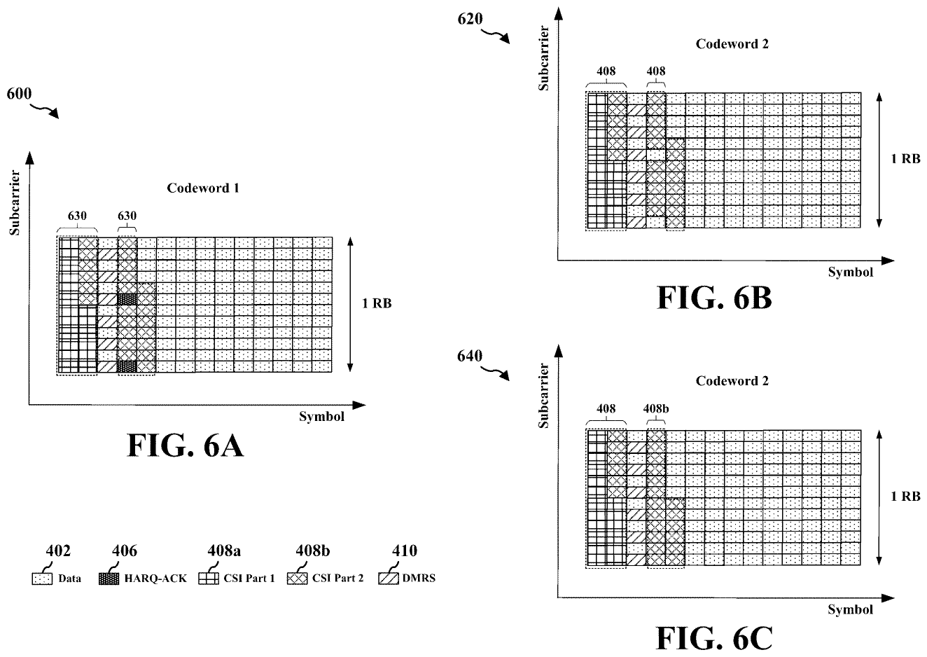

FIGS. 6A-6C illustrate resource diagrams 600-640 of codewords associated with a hybrid multiplexing of types of UCI. FIG. 6A can be paired with either FIG. 6B or FIG. 6C. Further, FIG. 6A may correspond to a detailed example of FIG. 5A. The UCI 630 for codeword 1 corresponds to the HARQ-ACK 406, the CSI part 1 408a, and the CSI part 2 408b, as illustrated in the diagram 600, whereas the CSI parts 408 for codeword 2 correspond to the CSI part 1 408a and the CSI part 2 408b, as illustrated in the diagrams 620-640, without the HARQ-ACK 406. The resource diagrams 600-640 also include data 402 and DMRS 410.

The UE may transmit some types of UCI 630, such as a first HARQ-ACK 406 with a smaller payload size (e.g., less than or equal to 11 bits), a second HARQ-ACK 406 with a larger payload size (e.g., greater than 11 bits), the CSI-part 1 408a, and/or the CSI-part 2 408b, in one codeword of a multi-codeword PUSCH transmission and transmit other combinations of UCI types 408 in multiple codewords of the multi-codeword PUSCH transmission. In some examples, the UCI transmissions being based on a single codeword or multiple codewords is predefined. In other examples, the network entity configures the UE to transmit the UCI 630 based on the single codeword or the multiple codewords through RRC signaling. The UE may report, to the network entity, a UE capability for the single codeword and multiple codeword UCI transmissions.

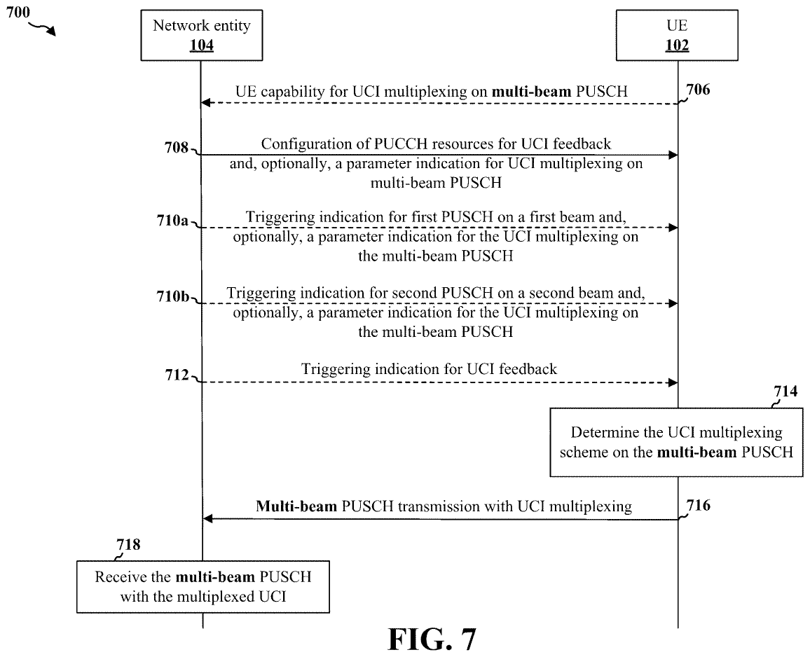

The UE may determine a resource mapping pattern for single codeword transmissions and multiple codeword transmissions. For UCI 630 in a single-codeword transmission, if the REs used for the HARQ-ACK 406, in the diagram 600, are available REs for PUSCH rate matching in other codewords, the UE may transmit data 402 at the available REs in the other codewords, as illustrated in the diagram 620. Alternatively, the UE may transmit CSI 408 (e.g., CSI part 2 408b) at the available REs in other codewords, as illustrated in the diagram 640. FIGS. 3-6C are directed to multi-codeword PUSCH transmissions, whereas FIGS. 7-9C are directed to multi-beam PUSCH transmissions.

FIG. 7 illustrates a signaling diagram 700 for a multi-beam PUSCH transmission based on UCI multiplexing. FIG. 7 is similar to FIG. 3, since a multi-beam PUSCH transmission may use the same number of codewords (i.e., multiple codewords) as the number of beams. In other examples, the UCI multiplexing is based on multiplexing schemes where the number of codewords is not the same as the number of beams. The UE 102 may report 706, to the network entity 104, a UE capability for UCI multiplexing on a multi-beam PUSCH. In other implementations, the network entity 104 may receive an indication of the UE capability from a core network, such as from an AMF. In yet other implementations, the network entity 104 may receive the indication of the UE capability from another base station/network entity (e.g., a gNB or an eNB). The UE capability report may indicate whether the UE 102 supports transmitting the UCI on a multi-beam based PUSCH and/or whether the UE 102 supports transmitting the UCI on a single PUSCH or multiple PUSCHs with different beams. The UE 102 may report 706 the UE capability per feature set, per band, per band combination, or per UE.

The network entity 104 indicates 708, to the UE 102, a configuration of PUCCH resources for UCI feedback (e.g., based on the UE capability). The network entity 104 may transmit 708 the configuration for the PUCCH resources for the UCI feedback through control signaling. The network entity 104 may use RRC signaling to indicate an RRCReconfiguration message to the UE 102 or a SIB, where the SIB may be a traditional type of SIB (e.g., SIB1) or a different SIB (e.g., SIB J, where J corresponds to an integer greater than 21) transmitted by the network entity 104.

For multi-beam PUSCH transmissions, the network entity 104 may also optionally transmit 708 a parameter indication to the UE 102 that indicates a UCI multiplexing scheme for the multi-beam PUSCH transmission. The network entity 104 may configure the UE 102 based on the parameter indication for the UCI multiplexing scheme through the same or different control signaling as transmitted 708 for the configuration of PUCCH resources. For example, the network entity 104 transmits 710a-710b, to the UE 102, a first triggering indication for a first PUSCH on a first beam and/or a second triggering indication for a second PUSCH on a second beam for the multi-beam PUSCH. The transmissions 710a-710b can also optionally include the parameter indication for the UCI multiplexing on the multi-beam PUSCH. Thus, the network entity 104 may transmit 710a-710b the parameter indication with one or more of the triggering indication(s), rather than transmitting 708 the parameter indication with the configuration.

The network entity 104 may additionally transmit 712, to the UE 102 through additional control signaling, a third triggering indication for triggering the UCI feedback from the UE 102. The third triggering indication triggers at least one PUCCH transmission having overlapped resources in time-domain with the PUSCH transmission(s). In some examples, the PUSCH(s) and the PUCCH resource are both configured in the first control signaling transmitted 708 to the UE 102. The network entity 104 may trigger 710a-710b the PUSCH(s) for the UE 102 to report the UCI feedback with or without data (e.g., aperiodic CSI or semi-persistent CSI). The network entity 104 may transmit 710a, 710b, 712 the triggering indication(s) based on a MAC-CE or DCI.

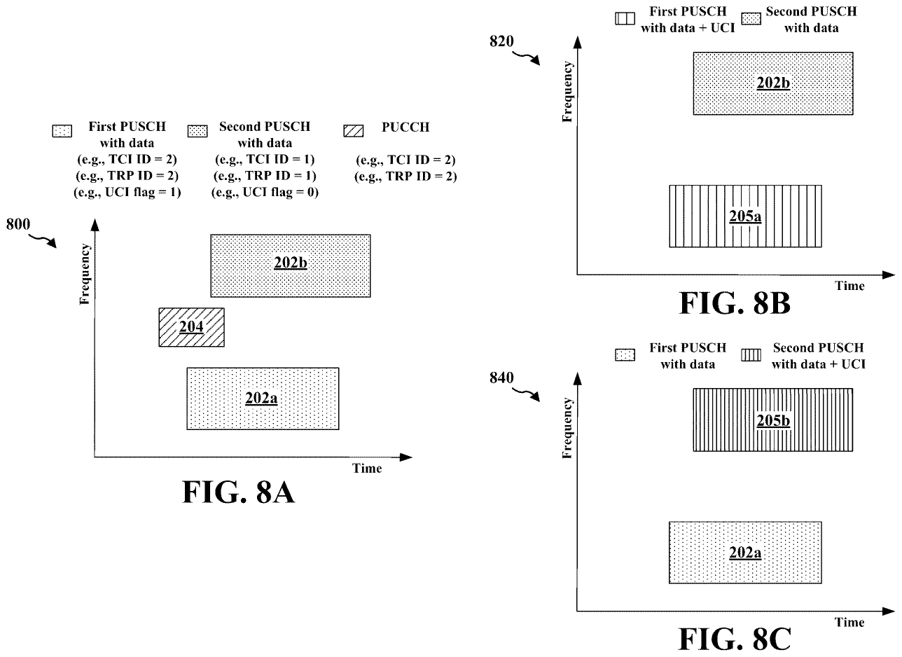

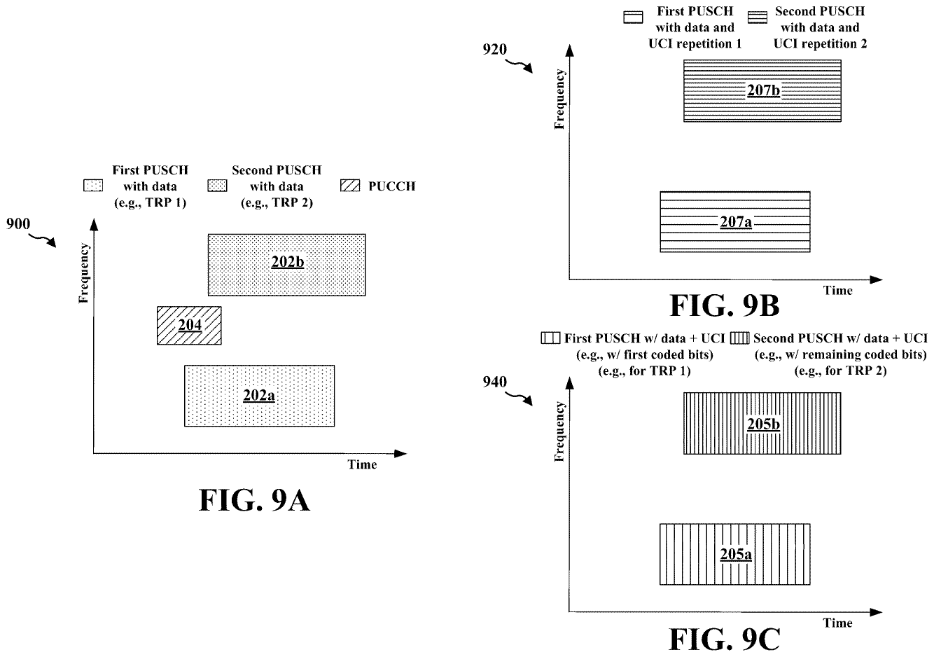

The UE 102 determines 714 how to multiplex the UCI associated with PUCCH resources on the PUSCH(s) based on one or more control signals that the UE 102 receives 708, 710a-710b, 712 from the network entity 104. Further details on the UE's determination of the UCI multiplexing scheme for the multi-beam PUSCH will described with respect to FIGS. 8A-9C. The UE 102 may transmit the UCI on one or more PUSCHs. In examples, the UE 102 determines 714 a UCI multiplexing scheme for the multi-beam PUSCH based on the parameter indication. The UE 102 can transmit 716, to the network entity 104, a multi-beam PUSCH transmission with UCI multiplexing. The network entity 104 also determines the multiplexing scheme based on the configured/indicated techniques to the UE 102 for receiving 718, from the UE 102, the multi-beam PUSCH with the multiplexed UCI. FIG. 7 illustrates signaling procedures for a multi-beam PUSCH, whereas FIGS. 8A-8C illustrate PUSCH resources for the multi-beam PUSCH.

FIGS. 8A-8C illustrate resource diagrams 800-820 associated with UCI multiplexing. FIG. 8A can be paired with either FIG. 8B or FIG. 8C. The UE may transmit the UCI associated with the PUCCH 204, as illustrated in the diagram 800, via one of the PUSCHs 202a-202b with data according to a predefined rule. The channel coding for the UCI is based on a modulation order and coding rate for a selected PUSCH 205a-205b with data and UCI. For example, the UE selects the first PUSCH 202a with data, from the diagram 800, as being the first PUSCH 205a with data and UCI in the diagram 820, whereas the UE selects the second PUSCH 202b with data, from the diagram 800, as being the second PUSCH 205b with data and UCI in the diagram 840.

The UE may select the PUSCH 205 for UCI multiplexing based on time-domain resources for the PUSCH 202. For instance, the UE may select the PUSCH 205a that starts first or ends first in time to reduce a UCI report latency, as illustrated in the diagram 820. In other examples, the UE selects the PUSCH 205b that starts later or ends later in time to reduce a UE complexity for UCI preparation, as illustrated in the diagram 840. If both PUSCHs 205 start or end at the same time, the UE may select the PUSCH 205 based on a beam index (e.g., the PUSCH 205 associated with the first or last transmission configuration indicator (TCI) or the TCI with a lower or higher ID among the TCIs indicated for both PUSCHs 205).

The UE may select the PUSCH 205 for UCI multiplexing based on the indicated TCI ID for the PUSCH 202 and the PUCCH 204. In an example, the first PUSCH 202a may have TCI ID=2, the second 202b may have TCI ID=1, and the PUCCH 204 may have TCI ID=2. The UE may select the first PUSCH 202a that has the same TCI ID as the PUCCH 204 or has a TCI that shares a same quasi-co-location (QCL) source reference signal as the PUCCH 204. The network entity may refrain from scheduling the PUCCH 204 and the PUSCH(s) 202 with different beams. In other examples, the UE selects one of the PUSCHs 202 based on a particular PUSCH having either the first or last TCI, or the lowest or highest TCI ID among the TCI IDs indicated for both PUSCHs 202.

The UE may also select the PUSCH 205 for UCI multiplexing based on a TRP ID (e.g., CORESETPoolIndex) for the PUSCH 202 and PUCCH 204. In an example, the first PUSCH 202a may have TRP ID=2, the second 202b may have TRP ID=1, and the PUCCH 204 may have TRP ID=2. The network entity may configure the TRP ID for the first PUSCH 202a, the second PUSCH 202b, and the PUCCH 204 through RRC signaling or MAC-CE. In other examples, the UE determines the TRP ID for the PUSCH 202 and PUCCH 204 based on the TRP ID for a scheduling physical downlink control channel (PDCCH). In still other examples, the UE may determine the TRP ID based on content for the PUCCH 204. For instance, the UE may determine the TRP ID based on the TRP ID for a measured downlink signal for the HARQ-ACK or CSI. The UE may select the PUSCH 202 with the same TRP ID as the PUCCH 204.

The UE may also select the PUSCH 205 for UCI multiplexing based on the MCS for each PUSCH 202. That is, the UE may select the PUSCH 202 with the higher MCS to transmit the PUSCH 205 with the UCI. If both PUSCHs 202 are scheduled with the same MCS, the UE may select the PUSCH 202 based on the beam index. The UE may also select the PUSCH 205 for UCI multiplexing based on the target coding rate or a number of coded bits for the UCI on each PUSCH 202. The UE may select the PUSCH 202 with a lower target coding rate or more coded bits to transmit the UCI. The UE determines the number of coded bits and the coding rate based on the beta offsets, the MCS, scheduled time-frequency resources, and the number of layers. If the target coding rate or the number of coded bits for the UCI on both PUSCHs 202 is the same, the UE may select the PUSCH 202 based on the beam index.

The network entity may configure or indicate a PUSCH 205 for UCI multiplexing through control signaling. The UE transmits the UCI associated with the PUCCH 204 on one of the PUSCHs 202 based on the received control signaling. The channel coding for the UCI is based on modulation order and coding rate for the selected PUSCH 205.

The network entity may configure the PUSCH 205 for UCI multiplexing by indicating a TRP ID for UCI multiplexing (e.g., CORESETPoolIndex through RRC signaling, PUSCH-Config, UCI-OnPUSCH, or CG-UCI-OnPUSCH). The UE may transmit the UCI on the PUSCH associated with the TRP ID. In some examples, the network entity configures the TRP ID for a PUCCH resource, and the UE transmits the UCI associated with the PUCCH 204 resource on the PUSCH 202 associated with the same TRP ID. The network entity may also configure the TRP ID in a TCI state or in association with the TCI state, such that the UE can transmit the UCI multiplexed on the PUSCH with the indicated TCI associated with the same TRP ID. Control signaling (e.g., RRC signaling) can be applied to a CG-PUSCH. For each CG-PUSCH, the network entity may configure an indicator for whether the UE can multiplex the UCI on a scheduled PUSCH 202. An RRC parameter may correspond to a 1-bit indicator, where a first state of the bit indicates that the UE may not multiplex the UCI on the scheduled PUSCH 202 and a second state of the bit may indicate the UE may multiplex the UCI on the scheduled PUSCH 205.

The network entity may also configure the PUSCH 205 for UCI multiplexing by indicating the TRP ID for UCI multiplexing (e.g., a CORESETPoolIndex) by MAC-CE. The MAC-CE may indicate a serving cell index, a BWP index, a PUCCH resource index, and/or the TRP ID. The UE transmits the UCI associated with the PUCCH 204 on the PUSCH 202a associated with the same TRP ID.

In some implementations, the network entity indicates whether the UE multiplexes the UCI on a scheduled PUSCH 202 by a DCI field. The DCI field may include a UCI multiplexing flag. In examples, the DCI field/UCI multiplexing flag may be a 1-bit indicator, where a first state of the bit/UCI flag indicates that the UE may not multiplex UCI on the scheduled PUSCH 202, and a second state of the bit/UCI flag indicates that the UE may multiplex UCI on the scheduled PUSCH 202. In the diagram 800, the first PUSCH 202a is associated with UCI flag=1 and the second PUSCH 202b is associated with UCI flag=0, where a value of 1 can indicate UCI multiplexing and a value of 0 can indicate no UCI multiplexing, or vice-versa.

FIGS. 9A-9C illustrate resource diagrams 900-920 associated with UCI multiplexing. FIG. 9A can be paired with either FIG. 9B or FIG. 9C. The UE may select one of the PUSCHs 202 to transmit the UCI. The UE may select the PUSCH 202 based on the beam quality. The UE transmits the UCI associated with the PUCCH 204 on the selected PUSCH 205/207. The channel coding for the UCI is based on the modulation order and coding rate for the selected PUSCH 205/207.

The UE may explicitly or implicitly report an index for the selected PUSCH to the network entity. For an explicit indication, the UE reports the selected PUSCH index in the beam report. The UE may report at least one group of beam indexes for simultaneous uplink transmission and may indicate an ID among the group of beams indicating the beam for a UCI report. The UE transmits the UCI on the PUSCH 205/207 with the indicated beam. For an implicit indication, the UE reports the selected PUSCH index based on DMRS or a PUSCH scrambling sequence selection. The network entity may configure two scrambling IDs for DMRS or PUSCH, where a first scrambling ID corresponds to a PUSCH 202a-202b without UCI and a second scrambling ID corresponds to a PUSCH 205a-205b/207a-207b with UCI.

The diagrams 920-940 include UCI multiplexing in both PUSCHs 205/207. In the diagram 920, the UE transmits UCI repetitions on both PUSCHs 205/207. That is, the UE transmits on a first PUSCH 207a with data and UCI repetition 1 and transmits on a second PUSCH 207b with data and UCI repetition 2. In the diagram 940, the UE transmits UCI on both PUSCHs 205/207 based on UCI partition. That is, the UE transmits a first part of the UCI (e.g., UCI part 1) on the first PUSCH 205a with data and UCI part 1 and transmits a second/remaining part of the UCI (e.g., UCI part 2) on the second PUSCH 205b with data and UCI part 2.

The UE may transmit the UCI, in the diagram 940, on the PUSCHs 205 associated with the same TRPs as the PUSCHs in the diagram 900. For example, the first PUSCHs 202a/205a correspond to TRP 1 and the second PUSCHs 202b/205b correspond to TRP 2. The UE may report HARQ-ACK for PDSCHs received from both TRPs, such that the UE may transmit the HARQ-ACK for the PDSCH from the first TRP on the first PUSCH 205a associated with the first TRP, and transmit the HARQ-ACK for the PDSCH from the second TRP on the second PUSCH 205b associated with the second TRP.

The UE may likewise report CSI for CSI-RSs received from both TRPs, such that the UE may transmit the CSI for the CSI-RS from the first TRP on the first PUSCH 205a associated with the first TRP, and transmit the CSI for CSI-RS from the second TRP on the second PUSCH 205b associated with the second TRP. The UE may perform independent channel coding for UCI in each PUSCH 205 based on the configuration for the PUSCH 205 (e.g., based on the MCS, beta offsets, time-frequency resources, or scaling factor).

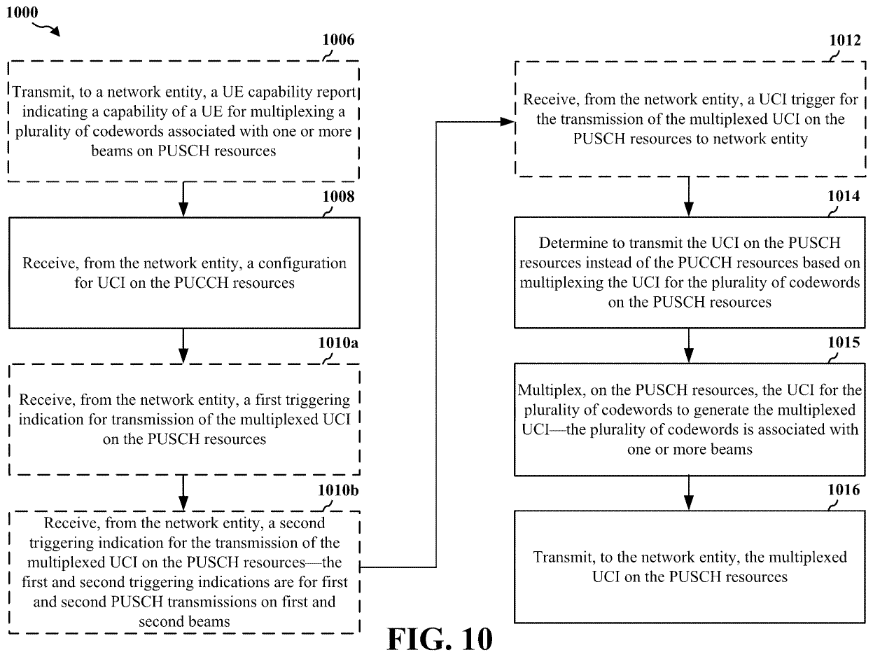

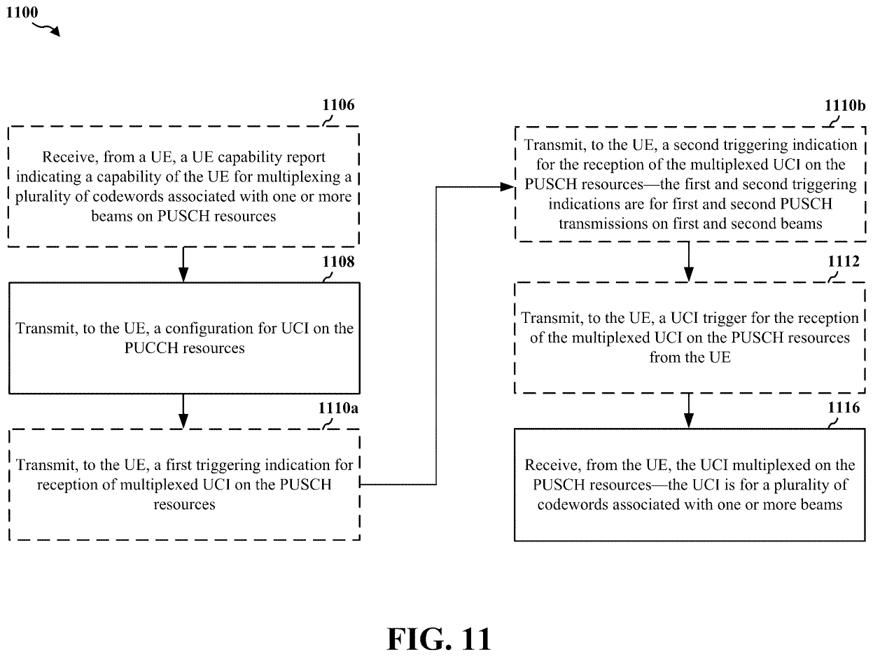

The UCI partition, in the diagram 940, may be based on a single channel coding. The UE can calculate a total number of coded bits across both PUSCHs 205. The UE may transmit a first part of the coded bits on the first PUSCH 205a with data and UCI based on a number of REs, a number of layers, and a modulation order for the first PUSCH 205a. The UE may transmit a second/remaining part of the coded bits on the second PUSCH 205b with data and UCI. The network entity may configure the UCI multiplexing scheme (e.g., single PUSCH UCI multiplexing, UCI repetitions on both PUSCHs 207, or UCI partitions on both PUSCHs 205) through RRC signaling, MAC-CE, or DCI. The UE may report, to the network entity, a UE capability and/or preference for a UCI multiplexing scheme using UE capability signaling or a UE assistance information message. FIGS. 3-9C describe UCI multiplexing for multi-codeword and multi-beam PUSCH. FIGS. 10-11 show methods for implementing one or more aspects of FIGS. 3-9C. In particular, FIG. 10 shows an implementation by the UE 102 of the one or more aspects of FIGS. 3-9C. FIG. 11 shows an implementation by the network entity 104 of the one or more aspects of FIGS. 3-9C.

FIG. 10 illustrates a flowchart 1000 of a method of wireless communication at a UE. With reference to FIGS. 1-9C and 12, the method may be performed by the UE 102, the UE apparatus 1202, etc., which may include the memory 1226′, 1206′, 1216, and which may correspond to the entire UE 102 or the entire UE apparatus 1202, or a component of the UE 102 or the UE apparatus 1202, such as the wireless baseband processor 1226 and/or the application processor 1206.

The UE 102 transmits 1006, to a network entity, a UE capability report indicating a capability of a UE for multiplexing a plurality of codewords associated with one or more beams on PUSCH resources. For example, referring to FIG. 3, the UE 102 transmits 306, to the network entity 104, a UE capability for UCI multiplexing on a multi-codeword PUSCH. Referring to FIG. 7, the UE 102 transmits 706, to the network entity 104, a UE capability for UCI multiplexing on a multi-beam PUSCH. In further examples, the UE capability report indicates a UE capability for UCI multiplexing on both multi-codeword and multi-beam PUSCH.

The UE 102 receives 1008, from the network entity, a configuration for UCI on the PUCCH resources. For example, referring to FIGS. 3 and 7, the UE 102 receives 308, 708, from the network entity 104, a configuration of PUCCH resources for UCI feedback.

The UE 102 receives 1010a, from the network entity, a first triggering indication for transmission of the multiplexed UCI on the PUSCH resources. For example, referring to FIG. 3, the UE 102 receives 310, from the network entity 104, a triggering indication for a multi-codeword PUSCH. Referring to FIG. 7, the UE 102 receives 710a, from the network entity 104, a triggering indication for a first PUSCH on a first beam.

The UE 102 receives 1010b, from the network entity, a second triggering indication for the transmission of the multiplexed UCI on the PUSCH resources the first and second triggering indications are for first and second PUSCH transmissions on first and second beams. For example, referring to FIG. 7, the UE 102 receives 710b, from the network entity 104, a triggering indication for a second PUSCH on a second beam, after reception 710a of the triggering indication for the first PUSCH on the first beam.

The UE 102 receives 1012, from the network entity, a UCI trigger for the transmission of the multiplexed UCI on the PUSCH resources to the network entity. For example, referring to FIGS. 3 and 7, the UE 102 receives 312, 712, from the network entity 104, a triggering indication for UCI feedback from the UE 102 to the network entity 104.

The UE 102 determines 1014 to transmit the UCI on the PUSCH resources instead of the PUCCH resources based on multiplexing the UCI for the plurality of codewords on the PUSCH resources. For example, referring to FIG. 3, the UE 102 determines 314 a UCI multiplexing scheme for the multi-codeword PUSCH. Referring to FIG. 7, the UE 102 determines 714 a UCI multiplexing scheme on a multi-beam PUSCH.

The UE 102 multiplexes 1015, on the PUSCH resources, the UCI for the plurality of codewords to generate the multiplexed UCI—the plurality of codewords is associated with one or more beams. For example, referring to FIGS. 5A-6C, the UE 102 multiplexes UCI 508 on codeword 1 and codeword 2. Referring to FIGS. 8A-8C, the UCI 508 is multiplexed on one beam. Referring to FIGS. 9A-9C, the UCI 508 is multiplexed on a plurality of beams. Multiplexing the UCI for the plurality of codewords can include UCI multiplexing of one codeword of the multi-codeword PUSCH and/or UCI multiplexing of all codewords of the multi-codeword PUSCH.

The UE 102 transmits 1016, to the network entity, the multiplexed UCI on the PUSCH resources. For example, referring to FIGS. 3-6C, the UE 102 transmits 316, to the network entity 104, a multi-codeword PUSCH transmission with UCI multiplexing. Referring to FIGS. 7-9C, the UE 102 transmits 716, to the network entity 104, a multi-beam PUSCH transmission with UCI multiplexing. FIG. 10 describes a method from a UE-side of a wireless communication link, whereas FIG. 11 describes a method from a network-side of the wireless communication link.

FIG. 11 is a flowchart 1100 of a method of wireless communication at a network entity. With reference to FIGS. 1-9C and 13, the method may be performed by one or more network entities 104, which may correspond to a base station or a unit of the base station, such as the RU 106, the DU 108, the CU 110, an RU processor 1306, a DU processor 1326, a CU processor 1346, etc. The one or more network entities 104 may include memory 1306′/1326′/1346′, which may correspond to an entirety of the one or more network entities 104, or a component of the one or more network entities 104, such as the RU processor 1306, the DU processor 1326, or the CU processor 1346.

The network entity 104 receives 1106, from a UE, a UE capability report indicating a capability of the UE for multiplexing a plurality of codewords associated with one or more beams on PUSCH resources. For example, referring to FIG. 3, the network entity 104 receives 306, from the UE 102, a UE capability for UCI multiplexing on a multi-codeword PUSCH. Referring to FIG. 7, the network entity 104 receives 706, from the UE 102, a UE capability for UCI multiplexing on a multi-beam PUSCH. In further examples, the UE capability report indicates a UE capability for UCI multiplexing on both multi-codeword and multi-beam PUSCH.

The network entity 104 transmits 1108, to the UE, a configuration for UCI on the PUCCH resources. For example, referring to FIGS. 3 and 7, the network entity 104 transmits 308, 708, to the UE 102, a configuration of PUCCH resources for UCI feedback.

The network entity 104 transmits 1110a, to the UE, a first triggering indication for reception of multiplexed UCI on the PUSCH resources. For example, referring to FIG. 3, the network entity 104 transmits 310, to the UE 102, a triggering indication for a multi-codeword PUSCH. Referring to FIG. 7, the network entity 104 transmits 710a, to the UE 102, a triggering indication for a first PUSCH on a first beam.

The network entity 104 transmits 1110b, to the UE, a second triggering indication for the reception of the multiplexed UCI on the PUSCH resources—the first and second triggering indications are for first and second PUSCH transmissions on first and second beams. For example, referring to FIG. 7, the network entity 104 transmits 710b, to the UE 102, a triggering indication for a second PUSCH on a second beam, after transmission 710a of the triggering indication for the first PUSCH on the first beam.

The network entity 104 transmits 1112, to the UE, a UCI trigger for the reception of the multiplexed UCI on the PUSCH resources from the UE. For example, referring to FIGS. 3 and 7, the network entity 104 transmits 312, 712, to the UE 102, a triggering indication for UCI feedback to the network entity 104 from the UE 102.

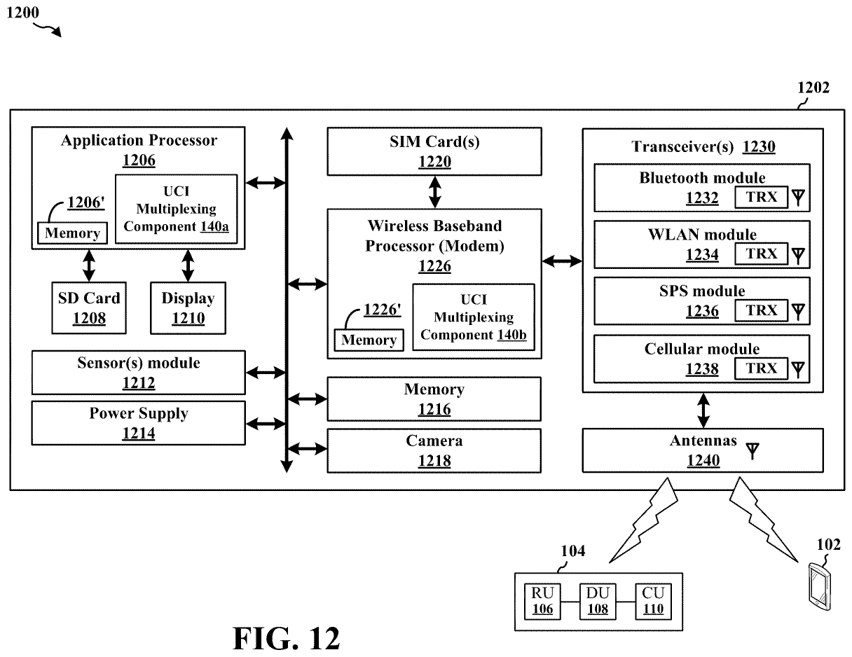

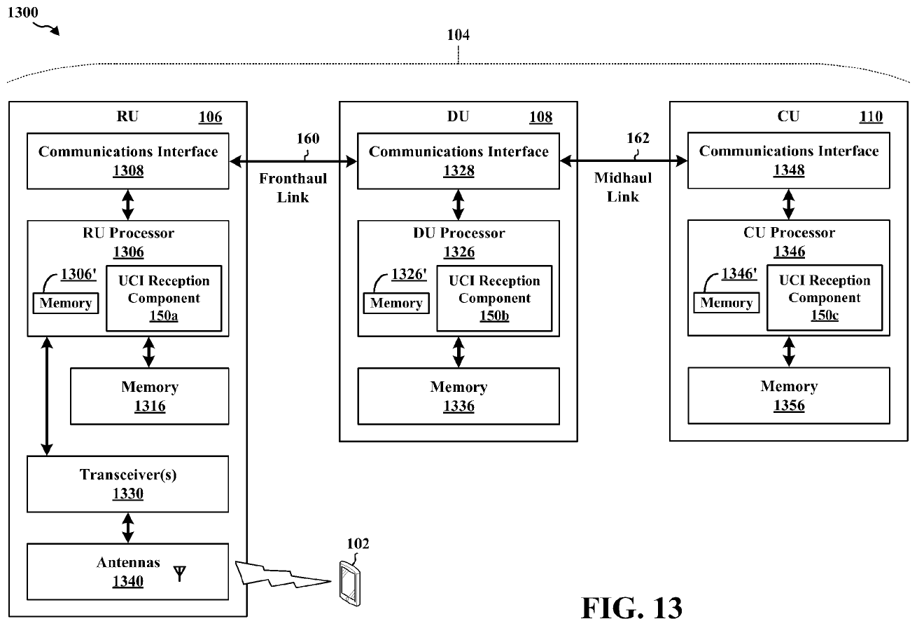

The network entity 104 receives 1116, from the UE, the UCI multiplexed on the PUSCH resources—the UCI is for a plurality of codewords associated with one or more beams. For example, referring to FIGS. 3-6C, the network entity 104 receives 316, from the UE 102, a multi-codeword PUSCH transmission with UCI multiplexing. Referring to FIGS. 7-9C, the network entity 104 receives 716, from the UE 102, a multi-beam PUSCH transmission with UCI multiplexing. A UE apparatus 1202, as described in FIG. 12, may perform the method of flowchart 1000. The one or more network entities 104, as described in FIG. 13, may perform the method of flowchart 1100.

FIG. 12 is a diagram 1200 illustrating an example of a hardware implementation for a UE apparatus 1202. The UE apparatus 1202 may be the UE 102, a component of the UE 102, or may implement UE functionality. The UE apparatus 1202 may include an application processor 1206, which may have on-chip memory 1206′. In examples, the application processor 1206 may be coupled to a secure digital (SD) card 1208 and/or a display 1210. The application processor 1206 may also be coupled to a sensor(s) module 1212, a power supply 1214, an additional module of memory 1216, a camera 1218, and/or other related components. For example, the sensor(s) module 1212 may control a barometric pressure sensor/altimeter, a motion sensor such as an inertial management unit (IMU), a gyroscope, accelerometer(s), a light detection and ranging (LIDAR) device, a radio-assisted detection and ranging (RADAR) device, a sound navigation and ranging (SONAR) device, a magnetometer, an audio device, and/or other technologies used for positioning.

The UE apparatus 1202 may further include a wireless baseband processor 1226, which may be referred to as a modem. The wireless baseband processor 1226 may have on-chip memory 1226′. Along with, and similar to, the application processor 1206, the wireless baseband processor 1226 may also be coupled to the sensor(s) module 1212, the power supply 1214, the additional module of memory 1216, the camera 1218, and/or other related components. The wireless baseband processor 1226 may be additionally coupled to one or more subscriber identity module (SIM) card(s) 1220 and/or one or more transceivers 1230 (e.g., wireless RF transceivers).

Within the one or more transceivers 1230, the UE apparatus 1202 may include a Bluetooth module 1232, a WLAN module 1234, an SPS module 1236 (e.g., GNSS module), and/or a cellular module 1238. The Bluetooth module 1232, the WLAN module 1234, the SPS module 1236, and the cellular module 1238 may each include an on-chip transceiver (TRX), or in some cases, just a transmitter (TX) or just a receiver (RX). The Bluetooth module 1232, the WLAN module 1234, the SPS module 1236, and the cellular module 1238 may each include dedicated antennas and/or utilize antennas 1240 for communication with one or more other nodes. For example, the UE apparatus 1202 can communicate through the transceiver(s) 1230 via the antennas 1240 with another UE 102 (e.g., sidelink communication) and/or with a network entity 104 (e.g., uplink/downlink communication), where the network entity 104 may correspond to a base station or a unit of the base station, such as the RU 106, the DU 108, or the CU 110.

The wireless baseband processor 1226 and the application processor 1206 may each include a computer-readable medium/memory 1226′, 1206′, respectively. The additional module of memory 1216 may also be considered a computer-readable medium/memory. Each computer-readable medium/memory 1226′, 1206′, 1216 may be non-transitory. The wireless baseband processor 1226 and the application processor 1206 may each be responsible for general processing, including execution of software stored on the computer-readable medium/memory 1226′, 1206′, 1216. The software, when executed by the wireless baseband processor 1226/application processor 1206, causes the wireless baseband processor 1226/application processor 1206 to perform the various functions described herein. The computer-readable medium/memory may also be used for storing data that is manipulated by the wireless baseband processor 1226/application processor 1206 when executing the software. The wireless baseband processor 1226/application processor 1206 may be a component of the UE 102. The UE apparatus 1202 may be a processor chip (e.g., modem and/or application) and include just the wireless baseband processor 1226 and/or the application processor 1206. In other examples, the UE apparatus 1202 may be the entire UE 102 and include the additional modules of the apparatus 1202.

As discussed in FIG. 1, the UCI multiplexing component 140 is configured to multiplex, on PUSCH resources, UCI for a plurality of codewords to generate a multiplexed UCI, the plurality of codewords being associated with one or more beams; and transmit, to a network entity, the multiplexed UCI on the PUSCH resources. The UCI multiplexing component 140 may be within the application processor 1206 (e.g., at 140a), the wireless baseband processor 1226 (e.g., at 140b), or both the application processor 1206 and the wireless baseband processor 1226. The UCI multiplexing component 140a-140b may be one or more hardware components specifically configured to carry out the stated processes/algorithm, implemented by one or more processors configured to perform the stated processes/algorithm, stored within a computer-readable medium for implementation by the one or more processors, or a combination thereof.

FIG. 13 is a diagram 1300 illustrating an example of a hardware implementation for one or more network entities 104. The one or more network entities 104 may be a base station, a component of a base station, or may implement base station functionality. The one or more network entities 104 may include, or may correspond to, at least one of the RU 106, the DU, 108, or the CU 110. The CU 110 may include a CU processor 1346, which may have on-chip memory 1346′. In some aspects, the CU 110 may further include an additional module of memory 1356 and/or a communications interface 1348, both of which may be coupled to the CU processor 1346. The CU 110 can communicate with the DU 108 through a midhaul link 162, such as an F1 interface between the communications interface 1348 of the CU 110 and a communications interface 1328 of the DU 108.

The DU 108 may include a DU processor 1326, which may have on-chip memory 1326′. In some aspects, the DU 108 may further include an additional module of memory 1336 and/or the communications interface 1328, both of which may be coupled to the DU processor 1326. The DU 108 can communicate with the RU 106 through a fronthaul link 160 between the communications interface 1328 of the DU 108 and a communications interface 1308 of the RU 106.

The RU 106 may include an RU processor 1306, which may have on-chip memory 1306′. In some aspects, the RU 106 may further include an additional module of memory 1316, the communications interface 1308, and one or more transceivers 1330, all of which may be coupled to the RU processor 1306. The RU 106 may further include antennas 1340, which may be coupled to the one or more transceivers 1330, such that the RU 106 can communicate through the one or more transceivers 1330 via the antennas 1340 with the UE 102.

The on-chip memory 1306′, 1326′, 1346′ and the additional modules of memory 1316, 1336, 1356 may each be considered a computer-readable medium/memory. Each computer-readable medium/memory may be non-transitory. Each of the processors 1306, 1326, 1346 is responsible for general processing, including execution of software stored on the computer-readable medium/memory. The software, when executed by the corresponding processor(s) 1306, 1326, 1346 causes the processor(s) 1306, 1326, 1346 to perform the various functions described herein. The computer-readable medium/memory may also be used for storing data that is manipulated by the processor(s) 1306, 1326, 1346 when executing the software. In examples, the UCI reception component 150 may sit at any of the one or more network entities 104, such as at the CU 110; both the CU 110 and the DU 108; each of the CU 110, the DU 108, and the RU 106; the DU 108; both the DU 108 and the RU 106; or the RU 106.

As discussed in FIG. 1, the UCI reception component 150 is configured to transmit, to a UE, a configuration for UCI on PUCCH resources; and receive, from the UE, the UCI multiplexed on PUSCH resources, the UCI being for a plurality of codewords associated with one or more beams. The UCI reception component 150 may be within one or more processors of the one or more network entities 104, such as the RU processor 1306 (e.g., at 150a), the DU processor 1326 (e.g., at 150b), and/or the CU processor 1346 (e.g., at 150c). The UCI reception component 150a-150c may be one or more hardware components specifically configured to carry out the stated processes/algorithm, implemented by one or more processors 1306, 1326, 1346 configured to perform the stated processes/algorithm, stored within a computer-readable medium for implementation by the one or more processors 1306, 1326, 1346, or a combination thereof.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Dashed lines may indicate optional elements of the diagrams. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The terms “may”, “might”, and “can”, as used in this disclosure, often carry certain connotations. For example, “may” refers to a permissible feature that may or may not occur, “might” refers to a feature that probably occurs, and “can” refers to a capability (e.g., capable of). The phrase “For example” often carries a similar connotation to “may” and, therefore, “may” is sometimes excluded from sentences that include “for example” or other similar phrases.

Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more.

Unless otherwise specifically indicated, ordinal terms such as “first” and “second” do not necessarily imply an order in time, sequence, numerical value, etc., but are used to distinguish between different instances of a term or phrase that follows each ordinal term. Reference numbers, as used in the specification and figures, are sometimes cross-referenced among drawings to denote same or similar features. A feature that is exactly the same in multiple drawings may be labeled with the same reference number in the multiple drawings. A feature that is similar among the multiple drawings, but not exactly the same, may be labeled with reference numbers that have different leading numbers, but have one or more of the same trailing numbers (e.g., 206, 306, 406, etc., may refer to similar features in the drawings). Sometimes an “X” is used to universally denote multiple variations of a feature. For instance, “X06” can universally refer to all reference numbers that end in “06” (e.g., 206, 306, 406, etc.).

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.
Example 1 is a method of wireless communication at a UE, including: multiplexing, on PUSCH resources, UCI for a plurality of codewords to generate a multiplexed UCI, the plurality of codewords being associated with one or more beams, e.g., one or more TCI states; and transmitting, to a network entity, the multiplexed UCI on the PUSCH resources.
Example 2 may be combined with Example 1 and further includes receiving, from the network entity, a configuration for UCI on PUCCH resources; and determining to transmit the UCI on the PUSCH resources instead of the PUCCH resources based on the multiplexing the UCI for the plurality of codewords on the PUSCH resources.
Example 3 may be combined with Example 2 and includes that the receiving the configuration for the UCI further includes: receiving an indication of a multiplexing scheme, wherein the multiplexing, on the PUSCH resources, the UCI for the plurality of codewords associated with the one or more beams is based on the indication of the multiplexing scheme.
Example 4 may be combined with Example 3 and includes that the indication of the multiplexing scheme includes a first parameter for performing the multiplexing for a multi-codeword PUSCH.
Example 5 may be combined with Example 4 and includes that the indication of the multiplexing scheme includes a second parameter for performing the multiplexing for a multi-beam PUSCH.
Example 6 may be combined with any of Examples 1-5 and further includes transmitting, to the network entity, a UE capability report indicating a capability of the UE for the multiplexing the plurality of codewords associated with the one or more beams on the PUSCH resources.
Example 7 may be combined with Example 6 and includes that the capability of the UE corresponds to at least one of: a first UCI multiplexing capability for the plurality of codewords, a second UCI multiplexing capability on the one or more beams, or a data transmission capability on same resource elements in a first codeword of the plurality of codewords as allocated for the UCI in a second codeword of the plurality of codewords.
Example 8 may be combined with any of Examples 1-7 and includes that the multiplexed UCI on the PUSCH resources corresponds to a repetition of the UCI or a partition of the UCI on same resources elements for the plurality of codewords.
Example 9 may be combined with any of Examples 1-7 and includes that the multiplexed UCI on the PUSCH resources corresponds to a repetition of the UCI or a partition of the UCI on different resources elements for the plurality of codewords.
Example 10 may be combined with any of Examples 1-7 and includes that the plurality of codewords includes a first codeword with the UCI and a second codeword without the UCI.
Example 11 may be combined with any of Examples 1-7 and includes that the plurality of codewords includes a first codeword with CSI and HARQ-ACK and a second codeword with the CSI and without the HARQ-ACK.
Example 12 may be combined with any of Examples 1-11 and further includes receiving, from the network entity, a first triggering indication for the transmitting the multiplexed UCI on the PUSCH resources.
Example 13 may be combined with Example 12 and further includes receiving, from the network entity, a second triggering indication for the transmitting the multiplexed UCI on the PUSCH resources, the first triggering indication being for a first PUSCH transmission on a first beam, the second triggering indication being for a second PUSCH transmission on a second beam.
Example 14 may be combined with any of Examples 12-13 and includes that at least one of the first triggering indication or the second triggering indication indicates a multiplexing scheme for the multiplexed UCI, the multiplexing scheme corresponding to at least one of a multi-codeword PUSCH transmission or a multi-beam PUSCH transmission.
Example 15 may be combined with any of Examples 1-14 and further includes receiving, from the network entity, a UCI trigger for the transmitting the multiplexed UCI on the PUSCH resources to network entity.
Example 16 may be combined with any of Examples 1-15 and includes that the transmitting the multiplexed UCI for the plurality of codewords is on a single beam.
Example 17 may be combined with any of Examples 1-15 and includes that the transmitting the multiplexed UCI for the plurality of codewords is on a plurality of beams.
Example 18 is a method of wireless communication at a network entity, including: transmitting, to a UE, a configuration for UCI on PUCCH resources; and receiving, from the UE, the UCI multiplexed on PUSCH resources, the UCI being for a plurality of codewords associated with one or more beams.
Example 19 may be combined with Example 18 and includes that the transmitting the configuration for the UCI further includes: transmitting an indication of a multiplexing scheme, wherein the multiplexing, on the PUSCH resources, the UCI for the plurality of codewords associated with the one or more beams is based on the indication of the multiplexing scheme.
Example 20 may be combined with Example 19 and includes that the indication of the multiplexing scheme includes a first parameter for performing the multiplexing for a multi-codeword PUSCH.
Example 21 may be combined with Example 20 and includes that the indication of the multiplexing scheme includes a second parameter for performing the multiplexing for a multi-beam PUSCH.
Example 22 may be combined with any of Examples 18-21 and further includes receiving, from the UE, a UE capability report indicating a capability of the UE for the multiplexing the plurality of codewords associated with the one or more beams on the PUSCH resources.
Example 23 may be combined with Example 22 and includes that the capability of the UE corresponds to at least one of: a first UCI multiplexing capability for the plurality of codewords, a second UCI multiplexing capability on the one or more beams, or a data transmission capability on same resource elements in a first codeword of the plurality of codewords as allocated for the UCI in a second codeword of the plurality of codewords.
Example 24 may be combined with any of Examples 18-23 and includes that the multiplexed UCI on the PUSCH resources corresponds to a repetition of the UCI or a partition of the UCI on same resources elements for the plurality of codewords.
Example 25 may be combined with any of Examples 18-23 and includes that the multiplexed UCI on the PUSCH resources corresponds to a repetition of the UCI or a partition of the UCI on different resources elements for the plurality of codewords.
Example 26 may be combined with any of Examples 18-23 and includes that the plurality of codewords includes a first codeword with the UCI and a second codeword without the UCI.
Example 27 may be combined with any of Examples 18-23 and includes that the plurality of codewords includes a first codeword with CSI and HARQ-ACK and a second codeword with the CSI and without the HARQ-ACK.
Example 28 may be combined with any of Examples 18-27 and further includes transmitting, to the UE, a first triggering indication for the receiving the multiplexed UCI on the PUSCH resources.
Example 29 may be combined with Examples 28 and further includes transmitting, to the UE, a second triggering indication for the receiving the multiplexed UCI on the PUSCH resources, the first triggering indication being for a first PUSCH transmission on a first beam, the second triggering indication being for a second PUSCH transmission on a second beam.
Example 30 may be combined with any of Examples 28-29 and includes that at least one of the first triggering indication or the second triggering indication indicates a multiplexing scheme for the multiplexed UCI, the multiplexing scheme corresponding to at least one of a multi-codeword PUSCH transmission or a multi-beam PUSCH transmission.
Example 31 may be combined with any of Examples 18-30 and further includes transmitting, to the UE, a UCI trigger for the receiving the multiplexed UCI on the PUSCH resources from the UE.
Example 32 may be combined with any of Examples 18-31 and includes that the receiving the multiplexed UCI for the plurality of codewords is on a single beam.
Example 33 may be combined with any of Examples 18-31 and includes that the receiving the multiplexed UCI for the plurality of codewords is on a plurality of beams.
Example 34 is an apparatus for wireless communication for implementing a method as in any of Examples 1-33.
Example 35 is an apparatus for wireless communication including means for implementing a method as in any of Examples 1-33.
Example 36 is a non-transitory computer-readable medium storing computer executable code, the code when executed by a processor causes the processor to implement a method as in any of Examples 1-33.

1. A method of wireless communication at a user equipment (UE), comprising:
multiplexing, on a physical uplink shared channel (PUSCH), uplink control information (UCI), to generate a multiplexed UCI using a codeword selected from a plurality of codewords, the codeword selected from the plurality of codewords having a highest modulation and coding scheme (MCS) index of the plurality of codewords; and
transmitting, to a network entity, the multiplexed UCI on the PUSCH, the PUSCH being associated with a same CORESETPoolIndex as for a physical uplink control channel (PUCCH) associated with the UCI.

2. The method of claim 1, further comprising:
receiving, from the network entity, a configuration for UCI on the PUCCH; and
determining to transmit the UCI on the PUSCH instead of the PUCCH based on the multiplexing the UCI on the PUSCH.

3. The method of claim 2, wherein the receiving the configuration for the UCI further comprises:
receiving an indication of a multiplexing scheme, wherein the multiplexing, on the PUSCH, the UCI is based on the indication of the multiplexing scheme.

4. (canceled)

5. The method of claim 1, further comprising:
transmitting, to the network entity, a UE capability report indicating a capability of the UE for the multiplexing the plurality of codewords on the PUSCH, wherein the capability of the UE corresponds to at least one of:
a first UCI multiplexing capability using the codeword,
a second UCI multiplexing capability on one or more beams, or
a data transmission capability on same resource elements in a first codeword of the plurality of codewords as allocated for the UCI in a second codeword of the plurality of codewords.

6. (canceled)

7. The method of claim 1, wherein the multiplexed UCI on the PUSCH corresponds to a repetition of the UCI or a partition of the UCI on same resource elements for the plurality of codewords.

8. The method of claim 1, wherein the multiplexed UCI on the PUSCH corresponds to a repetition of the UCI or a partition of the UCI on different resource elements for the plurality of codewords.

9. The method of claim 1, wherein the plurality of codewords includes a first codeword with the UCI and a second codeword without the UCI.

10. The method of claim 1, wherein the plurality of codewords includes a first codeword with channel state information (CSI) and hybrid automatic repeat request-acknowledgment (HARQ-ACK) and a second codeword with the CSI and without the HARQ-ACK.

11. The method of claim 1, further comprising:
receiving, from the network entity, a first triggering indication for the transmitting the multiplexed UCI on the PUSCH.

12. The method of claim 11, further comprising:
receiving, from the network entity, a second triggering indication for the transmitting the multiplexed UCI on the PUSCH, the first triggering indication being for a first PUSCH transmission on a first beam, the second triggering indication being for a second PUSCH transmission on a second beam.

13. (canceled)

14. The method of claim 1, further comprising:
receiving, from the network entity, a UCI trigger for the transmitting the multiplexed UCI on the PUSCH to network entity.

15. (canceled)

16. (canceled)

17. The method of claim 1, wherein the plurality of codewords have a same MCS index, the method further comprising:
selecting a first codeword of the plurality of codewords for the multiplexed UCI.

18. A method of wireless communication at a network entity, comprising:
receiving, from a user equipment (UE), uplink control information (UCI) multiplexed on a physical uplink shared channel (PUSCH), the UCI being received in a codeword selected from a plurality of codewords, the codeword selected from a plurality of codewords having a highest modulation and coding scheme (MCS) index of the plurality of codewords, and the PUSCH being associated with a same CORESETPoolIndex as for a physical uplink control channel (PUCCH) associated with the UCI.

19. The method of claim 18, wherein the plurality of codewords have a same MCS index, and the selected codeword is a first codeword of the plurality of codewords for the multiplexed UCI.

20. An apparatus for wireless communication comprising a memory, a transceiver, and a processor coupled to the memory and the transceiver, the processor being configured to:
multiplex, on a physical uplink shared channel (PUSCH), uplink control information (UCI) to generate a multiplexed UCI using a codeword selected from a plurality of codewords, the codeword selected from the plurality of codewords having a highest modulation and coding scheme (MCS) index of the plurality of codewords; and
transmit, to a network entity, the multiplexed UCI on the PUSCH, the PUSCH being associated with a same CORESETPoolIndex as for a physical uplink control channel (PUCCH) associated with the UCI.

21. The apparatus of claim 20, wherein the processor is further configured to:
receive, from the network entity, a configuration for UCI on the PUCCH; and
determine to transmit the UCI on the PUSCH instead of the PUCCH based on the multiplexing the UCI on the PUSCH.

22. The apparatus of claim 21, wherein, to receive the configuration for the UCI, the processor is configured to:
receive an indication of a multiplexing scheme, wherein the processor is configured to multiplex the UCI on the PUSCH based on the indication of the multiplexing scheme.

23. The apparatus of claim 20, wherein the processor is further configured to:
transmit, to the network entity, a UE capability report indicating a capability of the UE for multiplexing the plurality of codewords on the PUSCH, wherein the capability of the UE corresponds to at least one of:
a first UCI multiplexing capability using the codeword,
a second UCI multiplexing capability on one or more beams, or
a data transmission capability on same resource elements in a first codeword of the plurality of codewords as allocated for the UCI in a second codeword of the plurality of codewords.

24. The apparatus of claim 20, wherein the multiplexed UCI on the PUSCH corresponds to a repetition of the UCI or a partition of the UCI on same resource elements for the plurality of codewords.

25. The apparatus of claim 20, wherein the multiplexed UCI on the PUSCH corresponds to a repetition of the UCI or a partition of the UCI on different resource elements for the plurality of codewords.
